(19) United States
(12) Patent Application Publication
(10) Pub. No.: US 2026/0362330 A1
(43) Pub. Date: Nov. 12, 2026

(54) CHANNEL STATE MEASUREMENT AND PREDICTION CYCLES FOR DISCONTINUOUS RECEPTION

(71) Applicant: QUALCOMM Incorporated, San Diego, CA (US)

(72) Inventors: Mohamed Fouad Ahmed MARZBAN, San Diego, CA (US); Wooseok NAM, San Diego, CA (US); Tao LUO, San Diego, CA (US)

(21) Appl. No.: 19/203,115

(22) Filed: May 8, 2025

(51) Int. Cl. H04W 52/02

(52) U.S. Cl. CPC H04W 52/0235; H04W 52/0216

(57) ABSTRACT

Certain aspects of the present disclosure provide techniques for wireless communications. An example method includes obtaining signaling that indicates one or more first discontinuous reception (DRX)-on cycles and one or more second DRX-on cycles, the one or more first DRX-on cycles configured for channel state information (CSI) measurements and the one or more second DRX-on cycles configured for CSI predictions; and sending, based on the signaling, at least one of: the CSI measurements or the CSI predictions.

### INTRODUCTION

### Field of the Disclosure

Aspects of the present disclosure relate to wireless communications, and more particularly, to techniques for channel state feedback during discontinuous reception (DRX) communications.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes obtaining signaling that indicates one or more first discontinuous reception (DRX)-on cycles and one or more second DRX-on cycles, the one or more first DRX-on cycles configured for channel state information (CSI) measurements and the one or more second DRX-on cycles configured for CSI predictions; and sending, based on the signaling, at least one of: the CSI measurements or the CSI predictions.

Certain aspects provide a method for wireless communications by a network entity. The method includes sending signaling that indicates one or more first DRX-on cycles and one or more second DRX-on cycles, the one or more first DRX-on cycles configured for CSI measurements and the one or more second DRX-on cycles configured for CSI predictions; and obtaining, based on the signaling, at least one of: the CSI measurements or the CSI predictions.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts a process flow for closed-loop feedback associated with a communication channel between a network entity and a UE.

FIG. 6 depicts an example artificial intelligence (AI) architecture that may be used for AI-enhanced wireless communications.

FIG. 7 depicts an example AI architecture of a first wireless device that is in communication with a second wireless device.

FIG. 8 illustrates example channel state prediction by a UE.

FIG. 9 illustrates an example of a discontinuous reception (DRX) configuration.

FIGS. 10A and 10B depict various example aspects of communications with DRX.

FIG. 11 depicts an example of DRX configurations.

FIG. 12 depicts an example wireless communications network.

FIG. 13 depicts an example timeline for DRX communications.

FIG. 14 depicts a process flow for communications in a network between a network entity and a UE.

FIG. 15 depicts a method for wireless communications.

FIG. 16 depicts another method for wireless communications.

FIG. 17 depicts aspects of an example communications device.

FIG. 18 depicts aspects of an example communications device.

### DETAILED DESCRIPTION

Aspects of the present disclosure provide apparatuses, methods, processing systems, and computer-readable mediums for channel state information (CSI) measurement and prediction during discontinuous reception (DRX) communications.

A wireless communication system may include a number of devices and network entities employing techniques for exchanging information wirelessly. For example, a wireless communication system may include devices (e.g., user equipments (UEs)) and network entities (e.g., base stations (BS)) that wirelessly communicate data, control information, reference signals, etc. (e.g., according to various wireless communication system implementations). The wireless communication system may employ various technologies to improve throughput, achieve a high data rate, and/or improve the energy efficiency of the wireless communication system. These technologies may allow a wireless communication system to support communication between an increasing number of devices and network entities, support advanced functionalities at various devices, and improve the quality of communication between devices and network entities.

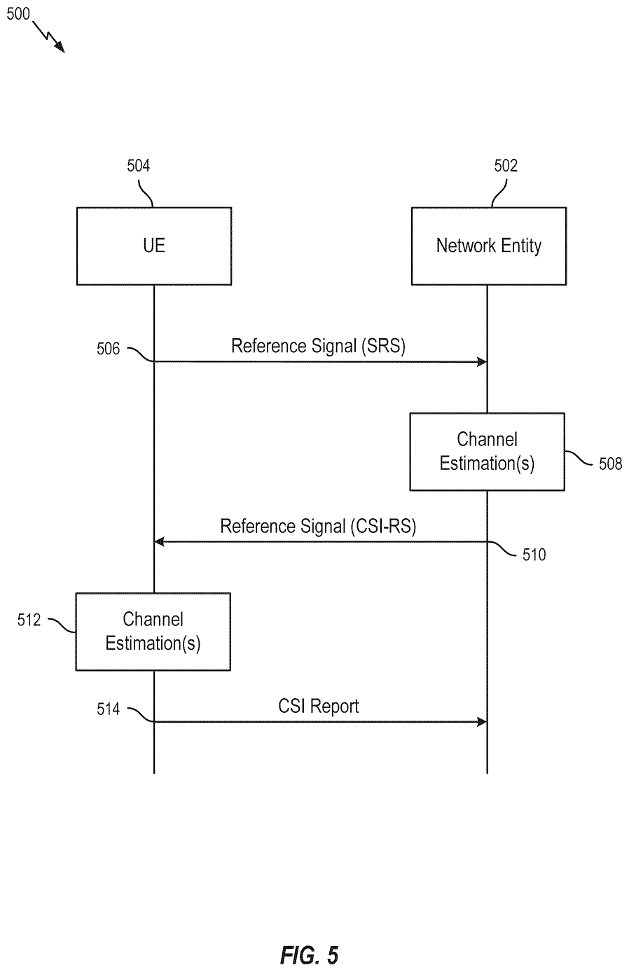

In certain cases, closed-loop feedback associated with a communication channel may be used to dynamically adapt communication parameters (e.g., modulation and coding scheme (MCS), beamforming, multiple-input and multiple-output (MIMO) layers, or the like) according to time varying channel conditions to improve the quality of communication between devices and network entities. For example, the time varying channel conditions may include channel conditions that change due to UE mobility, environment conditions, scattering, fading, interference, noise, or the like. As an example, a UE may monitor certain reference signals transmitted by a network entity (e.g., CSI reference signals (CSI-RSs), synchronization signal blocks (SSBs), etc.) and/or may perform measurements on the reference signals to obtain CSI. Subsequently, the UE may send a CSI report to the network entity, where the CSI report includes the obtained CSI. Subsequently, the network entity may adjust certain communication parameters in response to the CSI report transmitted by the UE. This closed-loop feedback scheme may be referred to as channel state feedback, CSI feedback, and/or CSI reporting. Channel state feedback is described in greater detail with respect to FIG. 5.

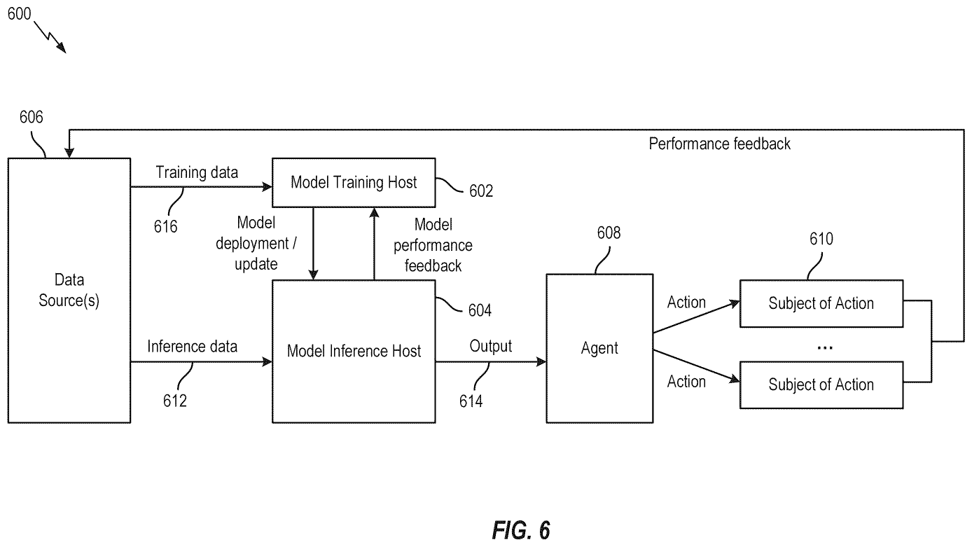

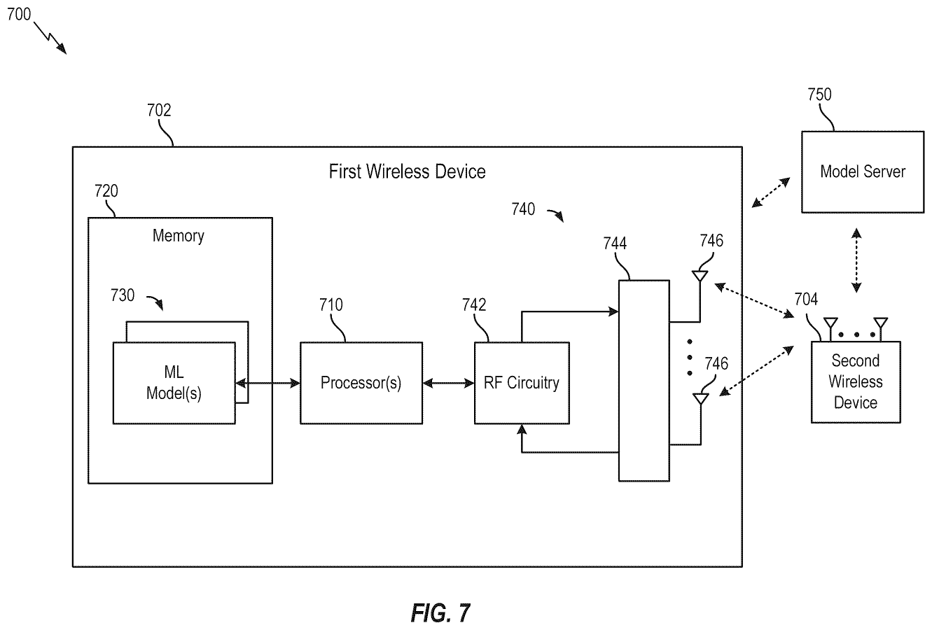

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data. ML models are described in greater detail with respect to FIGS. 6 and 7.

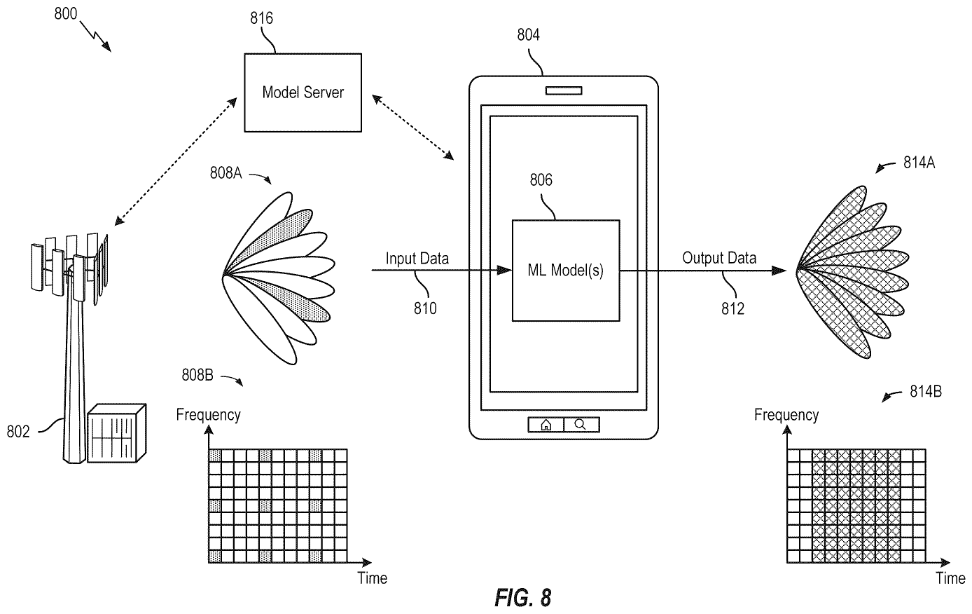

ML models may be deployed in one or more devices, such as network entities and/or UE(s), to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, positioning accuracy, transceiver tuning, beamforming, beam management, beam prediction, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like. An example implementation of an ML model for channel state feedback (e.g., CSI prediction) is depicted and described in greater detail with respect to FIG. 8.

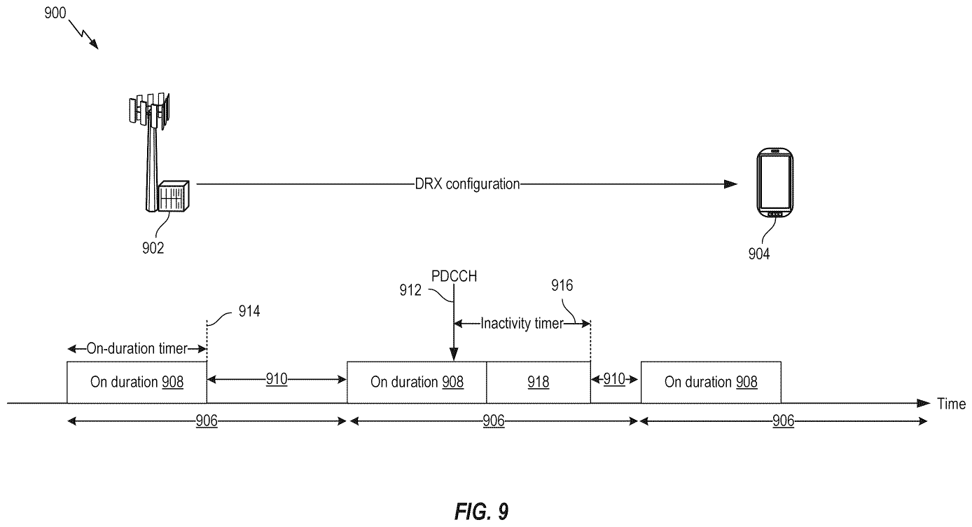

In certain cases, a device (e.g., a UE) may employ DRX operations to reduce power consumption and/or conserve battery of the device. For DRX operations, the device may periodically alternate between an active mode (e.g., “ON” or awake periods) during DRX-on durations and an inactive mode (e.g., “OFF,” sleep periods, or idle periods). During the active mode and/or the DRX-on durations, the device may power on at least a portion of its internal circuitry to monitor for messages or incoming data. Additionally or alternatively, in the inactive mode, the device may power down at least a portion of its internal circuitry (e.g., turning off and/or not delivering power to one or more components of the internal circuitry, such as one or more radio frequency (RF) elements) to reduce power consumption (e.g., battery power consumption), and the device is not expected to receive messages or data in the inactive mode. DRX operations and communications are described in greater detail with respect to FIG. 9.

In some aspects, DRX can be employed in a network for a device in both idle modes (e.g., the device is not registered to a particular cell but may still monitor for paging messages from the network) and connected modes (e.g., the device may have a radio resource control (RRC) connection established with the network and may be configured with parameters for communication with the network). For example, in the idle mode DRX (e.g., Paging Cycle, Paging DRX, etc.), a device periodically wakes up (e.g., powering on and/or delivering power to at least a portion of the internal circuitry, such as one or more RF elements) to monitor for paging messages during the DRX-on durations and goes back to the inactive mode (e.g., powers down the portions of the internal circuitry that were powered for monitoring for the paging messages) if a paging message is not intended for it. For the idle mode DRX, the device does not need to be in a connected state (also referred to as a “connected mode,” “RRC connected mode,” and/or “RRC connected state”) with the network. For example, for the idle mode DRX, the device may be in an inactive state (also referred to as an “inactive mode,” “RRC inactive mode,” and/or “RRC inactive state”) or in an idle state (also referred to as an “idle mode,” “RRC idle mode,” and/or “RRC idle state”). In some aspects, the inactive state may refer to the device having an RRC connection that has been suspended, but the device may be known on a radio access network (RAN)-based notification area (RNA) level in a particular RAN. Additionally or alternatively, the idle state may refer to the device not having an RRC connection established, but the device may be known at a tracking-area level in a core network (CN).

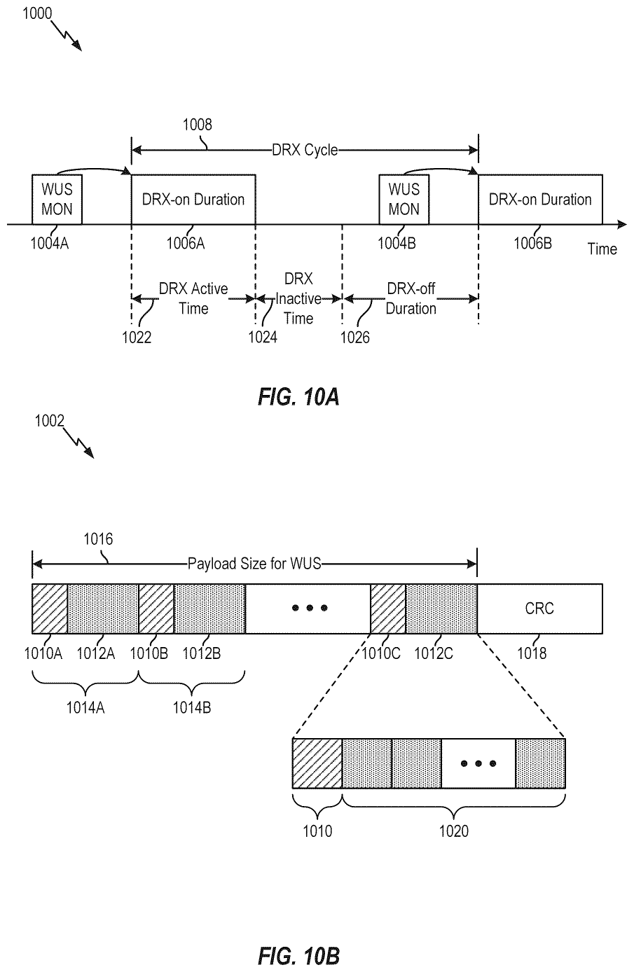

Additionally or alternatively, for the connected mode DRX (C-DRX), a device is in a connected state with the network and is actively sending or receiving data with a network entity. In C-DRX, the device periodically enters the inactive mode outside of the DRX-on durations, while still maintaining the connection to the network, and enters the active mode during the DRX-on durations to monitor a downlink channel for data or messages from the network entity and/or a cell (e.g., of the network entity). In some aspects, in C-DRX, prior to entering the active mode and/or prior to the DRX-on cycles, the device may monitor for a wake-up signal (WUS) from the network entity (e.g., outside of DRX active times, such as the DRX-on durations), where the WUS indicates whether the device should start a DRX-on duration timer for a DRX-on duration that corresponds to the WUS (e.g., a next occurring DRX-on duration after the WUS). The WUS is described in greater detail with respect to FIGS. 10A and 10B.

As described herein, a DRX active time may refer to time durations where a device (e.g., that is employing DRX) is running one or more timers (e.g., drx-onDurationTimer, drx-InactivityTimer, drx-RetransmissionTimerDL/UL, or ra-ContentionResolutionTimer) and/or other time durations where defined conditions are met. For example, DRX may be employed at a device based on parameters configured by the network. For example, a network entity may configure timing information (e.g., durations of the awake modes and the sleep modes, inactivity timers, retransmission timers, periodicity, etc.) based on semi-static signaling (e.g., RRC signaling) or dynamic signaling. Subsequently, DRX active time may include configured DRX-on durations (e.g., configured by the network entity as part of the parameters for DRX) that are considered activated, which may be referred to herein as DRX-on durations during DRX active time. In some aspects, a configured DRX-on duration may be considered activated based on a device receiving and decoding a WUS that indicates for the device to start a DRX-on duration timer for the configured DRX-on duration as described previously. Additionally or alternatively, a configured DRX-on duration may be considered activated based on the device not successfully decoding the WUS but a higher layer parameter (e.g., ps-Wakeup-r16 or ps-WakeupOrNot) indicates for the device to start the DRX-on duration timer (e.g., drx-onDurationTimer) for the configured DRX-on duration.

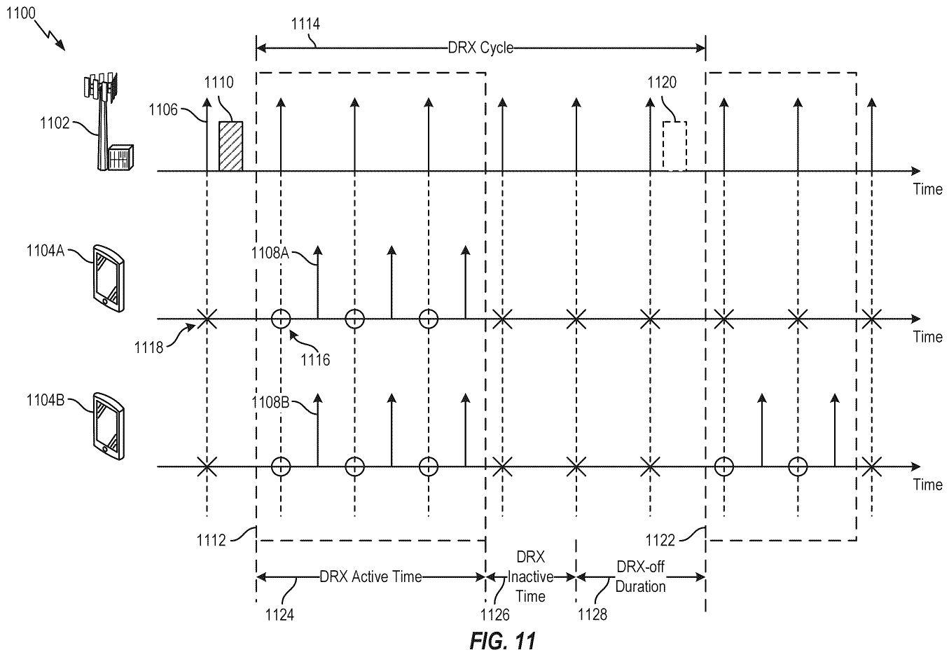

Additionally or alternatively, DRX-on durations outside DRX active time may refer to configured DRX-on durations that are considered deactivated. For example, DRX-on durations outside DRX active time may include time durations configured for a DRX-on duration timer (e.g., drx-onDurationTimer) when the DRX-on duration timer is not triggered and/or activated. In some aspects, a configured DRX-on duration may be considered deactivated based on a device receiving and decoding a WUS that indicates the device should not start the DRX-on duration timer for the configured DRX-on duration and/or the device did not successfully decode a WUS while a higher layer parameter (e.g., ps-Wakeup-r16 or ps-WakeupOrNot) indicating for the device to wake-up or not is also not provided. Activated and deactivated DRX-on durations are described in greater detail with respect to FIG. 11.

Technical problems for DRX operations may include, for example, when and how to report channel state feedback. In some cases, the network may configure a UE to measure and report CSI during activated and deactivated DRX-on durations. This configuration may enable the network to monitor changes in channel conditions for the UE (e.g., to maintain high link quality, improve beam management, and/or make improved scheduling and resource allocation decisions), but the UE may consume power to wake up for both the activated and deactivated DRX-on durations. Additionally or alternatively, the network may configure the UE to measure and report CSI during activated DRX-on durations. This configuration may enable the UE to save power by not waking up during deactivated DRX-on durations, but the network may not be able to monitor the channel conditions continually.

Aspects described herein may overcome the aforementioned technical problem(s), for example, by providing techniques for utilizing AI/ML models to predict CSI during deactivated DRX-on durations. For example, a UE may be configured to measure CSI on a first group of DRX-on cycles and to predict CSI on a second group of DRX-on cycles. In some aspects, a network entity may configure the UE with measurement DRX-on cycles (e.g., the first group of DRX-on cycles) and prediction DRX-on cycles (e.g., the second group of DRX-on cycles). For example, the network entity may configure the two DRX cycle groups for the measurement DRX-on cycles and for the prediction DRX-on cycles, or the network entity may configure a single DRX group for indicating both the measurement DRX-on cycles and the prediction DRX-on cycles. Additionally or alternatively, the measurement DRX-on cycles and the prediction DRX-on cycles may be determined based on a WUS. For example, when the UE receives a WUS, the UE may be triggered to measure CSI in a next DRX-on cycle and to predict CSI in one or more DRX-on cycles after the next DRX-on cycle.

In some aspects, the UE may be configured to report the predicted CSI with CSI reports during the measurement DRX-on cycles, or the UE may be configured to report the predicted CSI during the prediction DRX-on cycles. In some aspects, the UE may be configured to report the predicted CSI for a first periodic measurement resource in a predicted DRX-on cycle, for all periodic measurement resources in a predicted DRX-on cycle, or for a subset of periodic measurement resources in a predicted DRX-on cycle. In some aspects, the UE may provide recommendations and/or capabilities for the predicted CSI and/or parameters for the prediction DRX-on cycles.

Certain techniques for utilizing AI/ML models to predict CSI during deactivated DRX-on durations described herein may provide various beneficial technical effects and/or advantages. The techniques for predict CSI during deactivated DRX-on durations may enable improved wireless communications performance, such as reduced power consumption and improved tracking of channel conditions. The reduced power consumption and improved tracking of channel conditions may be attributable to the CSI predictions during deactivated DRX-on durations described herein, for example, due to the UE not waking up during the prediction DRX-on cycles to save power and the network entity obtaining continuous updates about measured and predicted CSI measurements.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

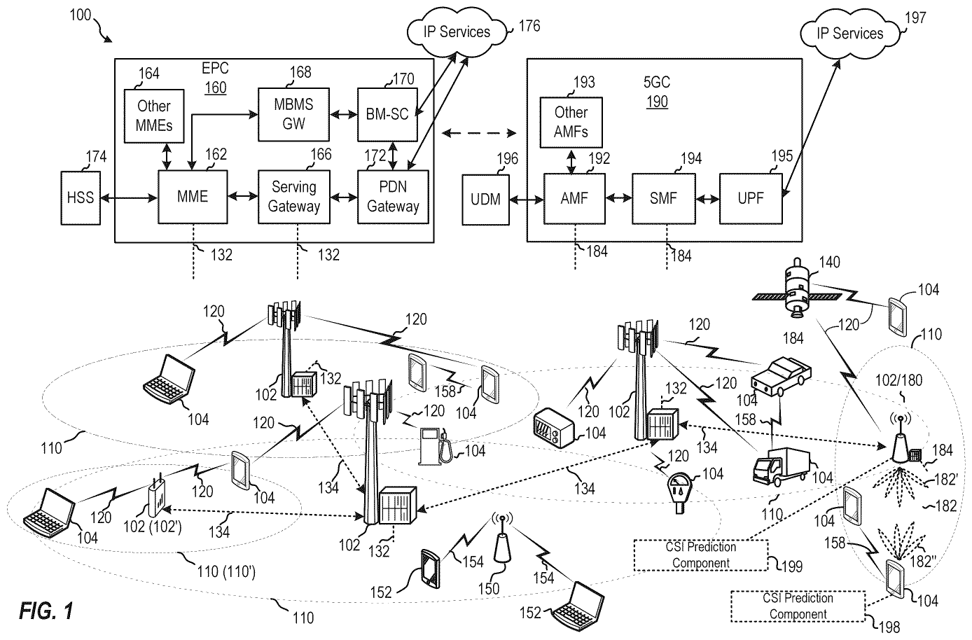

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more B Ss) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes B Ss 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gN B or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

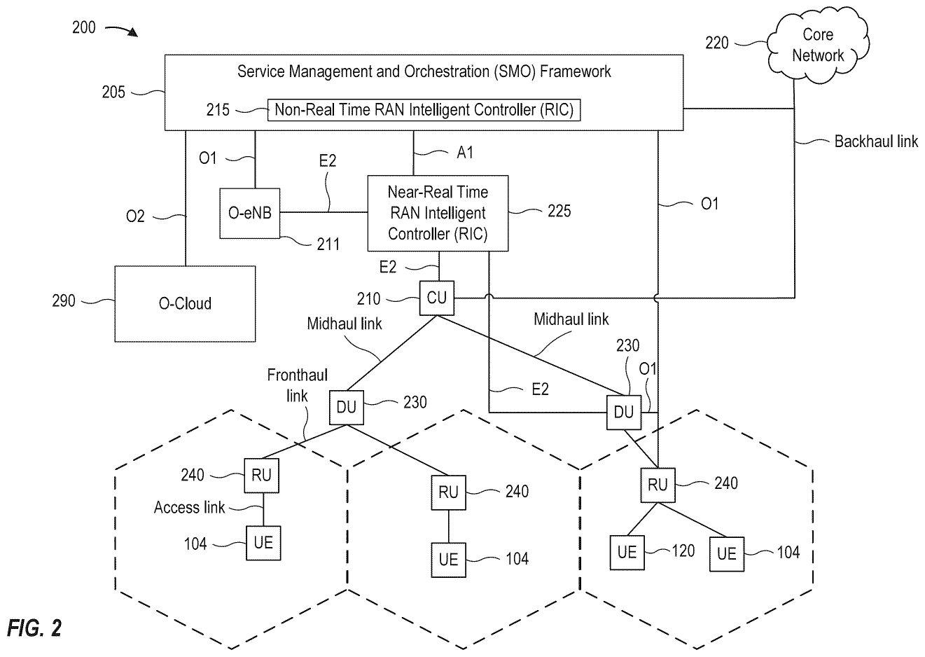

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UM TS) Terrestrial Radio Access Network (E-UTRAN)) may interface with the EPC 160 through first backhaul links 132 (e.g., an S1 interface). B Ss 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 megahertz (MHz)—7125 MHz, which is often referred to (interchangeably) as “Sub-6 gigahertz (GHz)”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., BS 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IM S), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SM F) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IM S, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

UE 104 includes a CSI prediction component 198, which may be used to predict CSI (e.g., via an AI/ML model) during deactivated DRX-on durations as further described herein. Further, a BS 102 includes a CSI prediction component 199, which may be used to signal configurations and/or parameters to enable CSI predictions during deactivated DRX-on durations as further described herein.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eN B (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

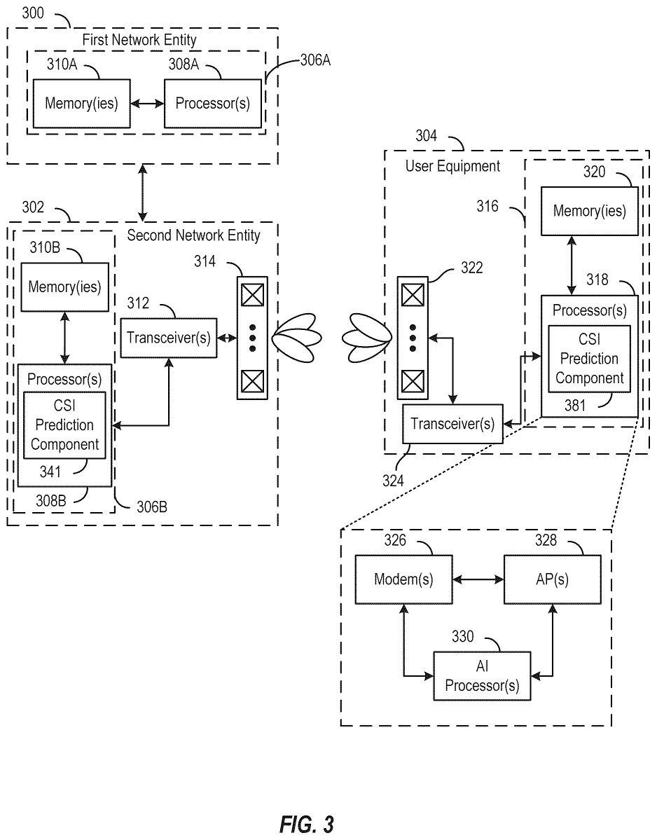

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306A” at first network entity 300 and “processing system 306B” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308A” and “processor(s) 308B”) and one or more memories 310 (illustrated as “memory(ies) 310A” and “memory(ies) 310B”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (A SIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGA s), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more A Ps 328 may provide a higher-level operating system (HLOS), software, audio or video processing, graphics processing, or the like. In some examples, the one or more A Ps 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a transmit (TX) MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, a receive (RX) MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for single-carrier frequency division multiplexing (SC-FDM)), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306B such as a modem and/or an RX MIMO detector), and further processed by the processing system 306B (e.g., a modem and/or a receive processor) to obtain decoded data and control information sent by UE 304. The processing system 306B may provide the decoded data and the decoded control information (such as to a controller/processor of the processing system 306B, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

In the depicted example, the processor(s) 308B includes a CSI prediction component 341, which may be representative of the CSI prediction component 199 of FIG. 1 Notably, while depicted as an aspect of processor(s) 308B, the CSI prediction component 341 may be implemented additionally or alternatively in various other aspects of a network entity or a BS 102 in other implementations. Further, the processor(s) 318 includes a CSI prediction component 381, which may be representative of the CSI prediction component 198 of FIG. 1 Notably, while depicted as an aspect of the processor(s) 318, the CSI prediction component 381 may be implemented additionally or alternatively in various other aspects of a UE 104 in other implementations.

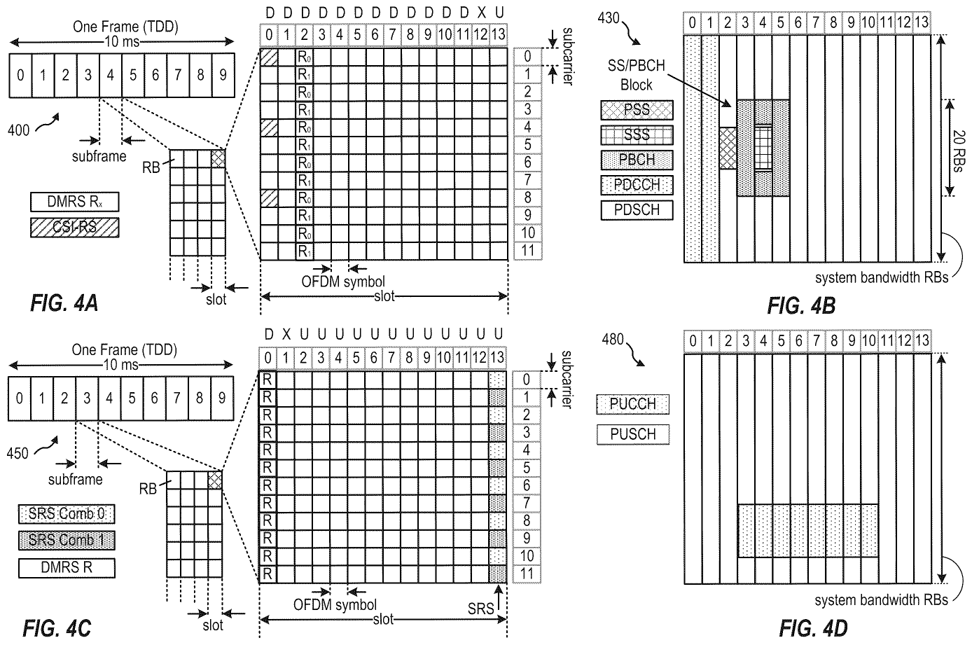

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and SC-FDM partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 KHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PB CH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ acknowledgment (ACK)/negative acknowledgment (NACK) feedback. The PUSCH carries data, and may additionally be used to carry a buffer status report (BSR), a power headroom report (PHR), and/or UCI.

### Aspects Related to Channel State Feedback

In certain wireless communication networks, closed-loop feedback associated with a communication channel between a UE and a network entity may be used to dynamically adapt communication parameters to channel conditions that may change over time. In certain cases, a UE may transmit a reference signal (e.g., DMRS, SRS, etc.), and a network entity (or another UE) may determine characteristics associated with the channel based on measurements of the received reference signal. In some cases, a UE may receive a reference signal (e.g., SSB, CSI-RS, DMRS, PT-RS, tracking reference signal (TRS), etc.) from a network entity (or another UE) and report channel state feedback to the network entity (or the other UE), where the channel state feedback is determined based on measurements of the reference signal received at the UE.

FIG. 5 depicts a process flow 500 for closed-loop feedback associated with a communication channel between a network entity 502 and a UE 504.

At 506, UE 504 sends a reference signal (e.g., SSB, CSI-RS, DMRS, PT-RS, SRS, etc.) to the network entity 502. In certain aspects, the UE 504 may send the reference signal (e.g. SRS) using one or more receive antenna ports, which may correspond to an SRS port or SRS antenna port. Transmission of the SRS via the receive antenna port may enable the network entity 502 to deduce the downlink propagation channel associated with the receive antenna port based on channel reciprocity.

At 508, the network entity 502 performs communications performance calculations (e.g., channel calculations) based on the reference signal, such as determining a channel matrix estimate H based on the received reference signal, for example, as further described herein with respect to the UE performing the communications performance calculations at 512. In certain aspects, the network entity 502 may further calculate, as part of the communications performance calculations, a precoder V (e.g., precoder matrix) based on the channel matrix estimate H, for example, as further described herein with respect to the UE 504 performing such a calculation. Accordingly, the network entity 502 may determine H and/or V for an uplink channel between UE 504 and network entity 502 based on SRS. Further, the uplink channel between UE 504 and network entity 502 may have reciprocity with a downlink channel between UE 504 and network entity 502. Accordingly, the determined values of H and/or V for the uplink channel between UE 504 and network entity 502 may be used for the downlink channel between UE 504 and network entity 502. In some cases, the reciprocity between the uplink channel and the downlink channel may be based on a known difference between the uplink channel and the downlink channel, such that the difference can be represented by a function. Accordingly, in certain aspects, to determine H and/or V for the downlink channel, the network entity 502 may apply a function to H and/or V determined for the uplink channel.

At 510, the UE 504 receives a reference signal (e.g., SSB, CSI-RS, etc.) from the network entity 502. In certain aspects, the network entity may send the reference signal with precoding (e.g., beamforming, MIMO layer(s), and/or compensation for signal propagation effects) based on the channel matrix estimate and/or precoder determined at 508.

At 512, the UE 504 performs channel calculations based on the reference signal, such as determining a channel matrix estimate H based on the received reference signal. For example, the UE 504 may include a demodulator or a baseband processor, which may be part of a modem (e.g., the modem(s) 326) of UE 504. The demodulator, such as a component of the modem, may obtain as input the reference signal as received over multiple antennas of the UE 504 and output (or determine) a vector y that is a representation of the received reference signal as received over each of the multiple antennas of the UE 504.

Based on a received signal model, the vector y can be represented as follows in equation (1):

\vec{y}=H\vec{x}+\vec{n} (1)

In equation (1), H corresponds to a matrix representation of the communications channel, as in a channel estimate of the communications channel the signal is communicated in (e.g., downlink communication channel where the reference signal is communicated), \vec{x} is the vector representing symbols transmitted by network entity 502 over a number of spatial layers, and \vec{n} is the additive noise observed with receiving antenna elements. In certain aspects, H has a size equal to the number of antennas used to receive the signaling, Nₐₙₜ, times the number of spatial layers, N_{I}, (e.g., the number of beamformed transmissions, number of antenna ports, etc.). For example, H has a number of rows equal to Nₐₙₜ and a number of columns equal to N_{I}. In certain aspects, the symbols that form the reference signal are known by the UE 504 (e.g., configured or preconfigured at the UE). UE 504 can determine the channel matrix estimate H based on receiving the reference signal.

In certain aspects, UE 504 may further calculate, as part of the calculations, a precoder V (e.g., precoder matrix) based on the channel matrix estimate H. For example, UE 504 may be configured to perform singular value decomposition (SVD) based precoding to determine the precoder V. For example, if the SVD of H leads to H=USV, such that SVD provides the precoder V. U may be related to the ordering of the rows of H, as in the ordering of the antennas as represented by H. It should be understood that other suitable techniques may be used to determine the precoder V based on the channel matrix estimate H.

At 514, UE 504 sends to the network entity 502 a CSI report indicating the determined channel matrix estimate H and/or precoder V. For example, the UE 504 may determine one or more CSI parameters, such as channel quality indicator (CQI), precoding matrix indicator (PMI), and/or rank indicator (RI) based on H and/or V. RI may represent the number of MIMO layers requested by the UE for downlink transmissions. PMI may define a set of indices corresponding to one or more precoding matrices (e.g., the precoding matrix V or a precoding matrix similar to V) to apply to downlink transmissions. In certain aspects, the PMI may indicate the UE's preferred precoding for downlink transmissions on the PDSCH. CQI may be an indicator of the UE's preferred modulation and coding scheme for downlink transmissions. The UE 504 may send an indication of the one or more determined CSI parameters to the network entity 502 in the CSI report. The network entity 502 may schedule downlink data transmissions to the UE 504 accordingly, such as using an MCS, code rate, number of MIMO layers, or the like, that the network entity determines based on the CSI report.

### Example Machine Learning/Artificial Intelligence for Wireless Communications

Aspects described herein may describe the performance of certain tasks and the technical solution of various technical problems by application of a specific type of ML model, such as an artificial neural network (ANN). It should be understood, however, that other type(s) of ML models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

FIG. 6 is a diagram illustrating an example AI architecture 600 that may be used for AI-enhanced wireless communications. As illustrated, the architecture 600 includes multiple logical entities, such as a model training host 602, a model inference host 604, data source(s) 606, and an agent 608. The AI architecture may be used in any of various use cases for wireless communications, such as those listed above.

The model inference host 604, in the architecture 600, is configured to run an ML model based on inference data 612 provided by data source(s) 606. The model inference host 604 may produce an output 614 (e.g., a prediction or inference, such as a discrete or continuous value) based on the inference data 612, that is then provided as input to the agent 608. In certain aspects, the model inference host 604 may be an example of a model inference agent.

The agent 608 may be an element or an entity of a wireless communication system including, for example, a radio access network (RAN), a wireless local area network, a device-to-device (D2D) communications system, etc. In certain examples, the agent 608 may be an example of a decision agent. In some examples, the agent 608 may be a UE, a base station, or any disaggregated network entity thereof including a CU, a DU, and/or an RU, an access point, a wireless station, a RIC in a cloud-based RAN, among some examples. Additionally, the type of agent 608 may also depend on the type of tasks performed by the model inference host 604, the type of inference data 612 provided to model inference host 604, and/or the type of output 614 produced by model inference host 604.

For example, if output 614 from the model inference host 604 is associated with CSI prediction, the agent 608 may be or include a UE, a DU, or an RU. As another example, if output 614 from model inference host 604 is associated with transmission and/or reception scheduling, the agent 608 may be a CU or a DU.

After the agent 608 receives output 614 from the model inference host 604, agent 608 may determine whether to act based on the output. For example, the agent 608 may be a UE, the output 614 from model inference host 604 may be one or more predicted channel characteristics (e.g., CSI predictions). For example, the model inference host 604 may predict channel characteristics for a set of beams based on the measurements of another set of beams. Based on the predicted channel characteristics, the agent 608, such as the UE, may send, to the subject of action 610, such as a BS, a request to switch to a different beam for communications. In some cases, the agent 608 and the subject of action 610 are the same entity.

The data sources 606 may be configured for collecting data that is used as training data 616 for training an ML model, or as inference data 612 for feeding an ML model inference operation. In particular, the data sources 606 may collect data from any of various entities (e.g., the UE and/or the BS), which may include the subject of action 610, and provide the collected data to a model training host 602 for ML model training. For example, after a subject of action 610 (e.g., a UE) receives a CSI prediction from agent 608, the subject of action 610 may provide performance feedback associated with the CSI prediction to the data sources 606, where the performance feedback may be used by the model training host 602 for monitoring and/or evaluating the ML model performance, such as whether the output 614, provided to agent 608, is accurate. In some examples, if the output 614 provided to agent 608 is inaccurate (or the accuracy is below an accuracy threshold), the model training host 602 may determine to modify or retrain the ML model used by model inference host 604, such as via an ML model deployment/update.

In certain aspects, the model training host 602 may be deployed at or with the same or a different entity than that in which the model inference host 604 is deployed. For example, in order to offload model training processing, which can impact the performance of the model inference host 604, the model training host 602 may be deployed at a model server as further described herein. Further, in some cases, training and/or inference may be distributed amongst devices in a decentralized or federated fashion.

In some aspects, an ML model is deployed at or on a UE (e.g., such as UE 104 in FIG. 1) for CSI predictions. More specifically, a model inference host, such as model inference host 604 in FIG. 6, may be deployed at or on the UE for obtaining CSI predictions.

FIG. 7 illustrates an example AI architecture 700 of a first wireless device 702 that is in communication with a second wireless device 704. The first wireless device 702 may be an example of UE 104 depicted and described with respect to FIG. 1 the UE 304 depicted and described with respect to FIG. 3, or the UE 504 depicted and described with respect to FIG. 5. Similarly, the second wireless device 704 may be an example of the BS 102 depicted and described with respect to FIG. 1 the first network entity 300 or the second network entity 302 depicted and described with respect to FIG. 3, a disaggregated base station depicted and described with respect to FIG. 2 or the network entity 502 depicted and described with respect to FIG. 5. Note that the AI architecture of the first wireless device 702 may be applied to the second wireless device 704.

The first wireless device 702 may be, or may include, a chip, system on chip (SoC), a system in package (SiP), chipset, package or device that includes one or more processors, processing blocks or processing elements (collectively “the processor 710”) and one or more memory blocks or elements (collectively “the memory 720”).

As an example, in a transmit mode, the processor 710 may transform information (e.g., packets or data blocks) into modulated symbols. As digital baseband signals (e.g., digital in-phase (I) and/or quadrature (Q) baseband signals representative of the respective symbols), the processor 710 may output the modulated symbols to a transceiver 740. The processor 710 may be coupled to the transceiver 740 for transmitting and/or receiving signals via one or more antennas 746. In this example, the transceiver 740 includes RF circuitry 742, which may be coupled to the antennas 746 via an interface 744. As an example, the interface 744 may include a switch, a duplexer, a diplexer, a multiplexer, and/or the like. The RF circuitry 742 may convert the digital signals to analog baseband signals, for example, using a digital-to-analog converter. The RF circuitry 742 may include any of various circuitry, including, for example, baseband filter(s), mixer(s), frequency synthesizer(s), power amplifier(s), and/or low noise amplifier(s). In some cases, the RF circuitry 742 may upconvert the baseband signals to one or more carrier frequencies for transmission. The antennas 746 may emit RF signals, which may be received at the second wireless device 704.

In receive mode, RF signals received via the antenna 746 (e.g., from the second wireless device 704) may be amplified and converted to a baseband frequency (e.g., downconverted). The received baseband signals may be filtered and converted to digital I or Q signals for digital signal processing. The processor 710 may receive the digital I or Q signals and further process the digital signals, for example, demodulating the digital signals.

One or more ML models 730 may be stored in the memory 720 and accessible to the processor(s) 710. In certain cases, different ML models 730 with different characteristics may be stored in the memory 720, and a particular ML model 730 may be selected based on its characteristics and/or application as well as characteristics and/or conditions of first wireless device 702 (e.g., a power state, a mobility state, a battery reserve, a temperature, etc.). For example, the ML models 730 may have different inference data and output pairings (e.g., different types of inference data produce different types of output), different levels of accuracies (e.g., 80%, 90%, or 95% accurate) associated with the predictions (e.g., the output 614 of FIG. 6), different latencies (e.g., processing times of less than 10 ms, 100 ms, or 1 second) associated with producing the predictions, different ML model sizes (e.g., file sizes), different coefficients or weights, etc.

The processor 710 may use the ML model 730 to produce output data (e.g., the output 614 of FIG. 6) based on input data (e.g., the inference data 612 of FIG. 6), for example, as described herein with respect to the model inference host 604 of FIG. 6 The ML model 730 may be used to perform any of various AI-enhanced tasks, such as those listed above.

As an example, the ML model 730 may take measurements of a reference signal (e.g., corresponding to a subset of beams) as input to predict a channel characteristic associated with a different reference signal (e.g., corresponding to a greater number of beams). The input data may include, for example, measurements of one or more reference or pilot signals, such as a channel quality indicator (CQI), a signal-to-noise ratio (SNR), a signal-to-interference plus noise ratio (SINR), a signal-to-noise-plus-distortion ratio (SNDR), a received signal strength indicator (RSSI), a reference signal received power (RSRP), a reference signal received quality (RSRQ), and/or a block error rate (BLER). The output data may include, for example, one or more predicted measurements (or characteristics) of one or more reference or pilot signals, which may be different from the reference or pilot signals associated with the input data. In certain aspects, the one or more reference or pilot signals for which the one or more measurements are predicted may be considered “virtual resources” in they are not actually transmitted, but the measurements are predicted as though they were transmitted. In certain aspects, the one or more reference or pilot signals for which the one or more measurements are predicted may actually be transmitted but not actually measured by first wireless device 702. Note that other input data and/or output data may be used in addition to or instead of the examples described herein. In certain aspects, a model server 750 may perform any of various ML model lifecycle management (LCM) tasks for the first wireless device 702 and/or the second wireless device 704. The model server 750 may operate as the model training host 602 and update the ML model 730 using training data. In some cases, the model server 750 may operate as the data source 606 (e.g., described and depicted in the example of FIG. 6) to collect and host training data, inference data, and/or performance feedback associated with an ML model 730. In certain aspects, the model server 750 may host various types and/or versions of the ML models 730 for the first wireless device 702 and/or the second wireless device 704 to download.

In some cases, the model server 750 may monitor and evaluate the performance of the ML model 730 to trigger one or more LCM tasks. For example, the model server 750 may determine whether to activate or deactivate the use of a particular ML model at the first wireless device 702 and/or the second wireless device 704, and the model server 750 may provide such an instruction to the respective first wireless device 702 and/or the second wireless device 704. In some cases, the model server 750 may determine whether to switch to a different ML model 730 being used at the first wireless device 702 and/or the second wireless device 704, and the model server 750 may provide such an instruction to the respective first wireless device 702 and/or the second wireless device 704. In yet further examples, the model server 750 may also act as a central server for decentralized machine learning tasks, such as federated learning.

### Aspects of ML Model Training

There are a variety of model training techniques and processes that may be used prior to, or at some point following, deployment of an ML model.

As part of a model development process, information in the form of applicable training data may be gathered or otherwise created for use in training an ML model accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in one or more UEs, one or more network entities, or one or more other devices in a wireless communication system. In some cases, all or part of the training data may be aggregated from multiple sources (e.g., one or more UEs, one or more network entities, the Internet, etc.). For example, wireless network architectures, such as self-organizing networks (SONs) or mobile drive test (MDT) networks, may be adapted to support collection of data for ML model applications. In another example, training data may be generated or collected online, offline, or both online and offline by a UE, network entity, or other device(s), and all or part of such training data may be transferred or shared (in real or near-real time), such as through store and forward functions or the like. Offline training may refer to creating and using a static training dataset, e.g., in a batched manner, whereas online training may refer to a real-time or near-real-time collection and use of training data. For example, an ML model at a network device (e.g., a UE) may be trained and/or fine-tuned using online or offline training. For offline training, data collection and training can occur in an offline manner at the network side (e.g., at a base station or other network entity) or at the UE side. For online training, the training of a UE-side ML model may be performed locally at the UE or by a server device (e.g., a server hosted by a UE vendor) in a real-time or near-real-time manner based on data provided to the server device from the UE.

In certain instances, all or part of the training data may be shared within a wireless communication system, or even shared (or obtained from) outside of the wireless communication system.

Once an ML model has been trained with training data, its performance may be evaluated. In some scenarios, evaluation/verification tests may use a validation dataset, which may include data not in the training data, to compare the model's performance to baseline or other benchmark information. If model performance is deemed unsatisfactory, it may be beneficial to fine-tune the model, e.g., by changing its architecture, re-training it on the data, or using different optimization techniques, etc. Once a model's performance is deemed satisfactory, the model may be deployed accordingly. In certain instances, a model may be updated in some manner, e.g., all or part of the model may be changed or replaced, or undergo further training, just to name a few examples.

As part of a training process for an ML model, parameters affecting the functioning of the artificial neurons and layers may be adjusted. For example, backpropagation techniques may be used to train the ML model by iteratively adjusting weights and/or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and/or biases to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model.

A “dropout” technique may be used to randomly drop out some of the artificial neurons from a model during a training process, e.g., in order to reduce overfitting and potentially improve the generalization of the model.

An “early stopping” technique may be used to stop an on-going training process early, such as when a performance of the model using a validation dataset starts to degrade.

Another example technique includes data augmentation to generate additional training data by applying transformations to all or part of the training information.

A transfer learning technique may be used which involves using a pre-trained model as a starting point for training a new model, which may be useful when training data is limited or when there are multiple tasks that are related to each other.

A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ML model is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training on data distributed across multiple devices or organizations, without the need to centralize data or the training. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ML model to be trained on data collected from a wide range of devices and environments. For example, an ML model may be trained on data collected from a large number of wireless devices in a network, such as distributed wireless communication nodes, smartphones, or internet-of-things (IoT) devices, to improve the network's performance and efficiency. With federated learning, a UE or other device may receive a copy of all or part of a model and perform local training on such copy of all or part of the model using locally available training data. Such a device may provide update information (e.g., trainable parameter gradients) regarding the locally trained model to one or more other devices (such as a network entity or a server) where the updates from other-like devices (such as other UEs) may be aggregated and used to provide an update to a shared model or the like. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to a ML model's usage, maintenance, activation, reporting, or the like. In certain instances, all or part of a dataset or model may be shared across multiple devices, e.g., to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as, a CU, a DU, an RU, or the like.

As an example, AI/ML techniques have been introduced to help reduce the complexity involved in CSI measurement and prediction and the overhead associated with CSI measurement without sacrificing system performance. For example, with the help of AI/ML techniques, CSI can be predicted for future occasions.

FIG. 8 is a diagram illustrating example CSI prediction 800 by a UE (e.g., a time-domain CSI prediction using a UE sided model). In this example, one or more ML models (hereinafter “the ML model 806”) are deployed at or on the UE 804 to enable the UE 804 to make one or more beam predictions based on data input to ML model 806. The UE 804 may be an example of UE 104 depicted and described with respect to FIG. 1 the UE 304 depicted and described with respect to FIG. 3, the UE 504 depicted and described with respect to FIG. 5, or the first wireless device 702 depicted and described with respect to FIG. 7.

A network node 802 (e.g., a base station or any disaggregated entity thereof) may transmit one or more signals (e.g., SSB(s), DMRS(s), CSI-RS(s), CSI interference measurement (IM) resource(s)), via a first set of transmit beams 808A, in a first set of communication resources 808B (e.g., an SSB resource, a DMRS resource, a CSI-RS resource, and/or a CSI-IM resource). That is, a set of channel and/or interference measurement resources (e.g., CSI-RS, CSI-IM, SSB) may be utilized as an input to a CSI prediction algorithm to predict the CSI on a set of future resources. The network node 802 may be an example of the BS 102 depicted and described with respect to FIG. 1 the first network entity 300 or the second network entity 302 depicted and described with respect to FIG. 3, a disaggregated base station depicted and described with respect to FIG. 2 the network entity 502 depicted and described with respect to FIG. 5, or the second wireless device 704 depicted and described with respect to FIG. 7.

The UE 804 may perform measurements (e.g., CSI measurements) of at least one signals transmitted in the first set of communication resources 808B, or a subset thereof, to obtain input data, which may include a first set of measurements 810 (sometimes referred to as parameters, channel characteristics, or channel properties). For example, a subset of the first set of transmit beams 808A may be associated with one or more measurements 810 performed by UE 804. The UE 804 may feed the first set of measurements 810 (e.g., CSI measurement values) into the ML model 806. For example, the first set of measurements 810 may include sparse channel and/or interference measurements on subsets of slots, sub-bands, and/or beams. The set of measurement resources may vary in time (e.g., slots) and/or space (e.g., beams) and/or frequency (e.g., sub-bands). In some aspects, the ML model 806 may be referred to as a CSI prediction algorithm and may include a deep neural network (e.g., recurrent neural network (RNN), convolutional neural network (CNN), Transformer, etc.), a classical ML model (e.g., support vector machine (SVM), random forest, K-nearest neighbors (KNN), etc.), an autoregressive approach, a minimum mean square error (MMSE) predictor approach, or another type of AI/ML algorithm.

The ML model 806 may provide output data, for example, including an indication of a second set of measurements 812. As part of AI-based CSI prediction, the second set of measurements 812 may include one or more predicted measurement values for a second set of communication resources associated with a second set of transmit beams 814A. As an example, the second set of measurements 812 may include one or more predicted channel characteristics (e.g., predicted CSI values) associated with the second set of communication resources, where the second set of communication resources 814B are associated with the second set of transmit beams 814A. For example, the output of the ML model 806 may include predicted SINRs on all or a subset future beams, slots, and/or sub-bands. In some aspects, the UE 804 may report the CSI on all predicted resources or a subset of predicted resources from the second set of communication resources 814B. In certain cases, the UE 804 may perform measurements of one or more signals transmitted in the second set of communication resources, or a subset thereof, to obtain the second set of measurements 812, for example, as a part of training data collection and/or performance monitoring for the ML model 806.

Use of the ML model 806 for CSI prediction may reduce the amount of times the UE 804 needs to wake up to obtain channel and/or interference measurement resources, thereby conserving power at the UE 804 and/or network resources that would have otherwise been used to send the channel and/or interference measurement resources.

In certain aspects, a model server 816 (in communication with the UE 804 and/or the network node 802) may perform any of various ML model lifecycle management (LCM) tasks for the UE 804 and/or the network node 802. The model server 816 may operate as the model training host 602 (e.g., depicted and described with respect to FIG. 6) and update the ML model 806 using training data. In some cases, the model server 816 may operate as the data source 606 (e.g., depicted and described with respect to FIG. 6) to collect and host training data, inference data, and/or performance feedback associated with an ML model 806. In certain aspects, the model server 816 may host various types and/or versions of the ML model 806 for the UE 804 and/or the network node 802 to download.

In some cases, the model server 816 may monitor and evaluate the performance of the ML model 806 to trigger one or more LCM tasks. For example, the model server 816 may determine whether to activate or deactivate the use of a particular ML model at the UE 804 and/or the network node 802, and the model server 816 may provide such an instruction to the respective UE 804 and/or the network node 802. In some cases, the model server 816 may determine whether to switch to a different ML model 806 being used at the UE 804 and/or the network node 802, and the model server 816 may provide such an instruction to the respective UE 804 and/or the network node 802. In yet further examples, the model server 816 may also act or operate as a central server for decentralized machine learning tasks, such as federated learning.

### Aspects Related to DRX Communications

FIG. 9 depicts an example 900 of a DRX configuration. As shown, a network entity 902 may transmit, and a UE 904 may receive, a DRX configuration. The network entity 902 may be an example of the BS 102 of FIG. 1 the first network entity 300 or the second network entity 302 of FIG. 3, or a disaggregated base station as discussed with respect to FIG. 2 The UE 904 may be an example of the UE 104 of FIG. 10r UE 304 of FIG. 3.

The DRX configuration may configure a DRX cycle 906. A DRX cycle 906 may include a DRX on duration 908 (for example, during which a UE 904 is awake or in an active state) and an opportunity to enter a DRX sleep state 910. The time during which the UE 904 is configured to be in an active state during the DRX on duration 908 plus any extension of the DRX on duration 908 (for example, due to an inactivity timer) may be referred to as an active time period of the DRX cycle 906. The time during which the UE 904 is configured to be in the DRX sleep state 910 may be referred to as an inactive time period (or a DRX off duration) of the DRX cycle 906. The UE 904 may monitor a downlink control channel (for example, a PDCCH) during the active time period, and the UE 904 may refrain from monitoring the downlink control channel during the inactive time period. In certain cases, the UE 904 may enter a lower power state during the inactive time period. Thus, the DRX cycle 906 may enable power savings at the UE 904, for example, due to periodic monitoring of the downlink control channel.

During the DRX on duration 908, the UE 904 may monitor a control channel, such as the PDCCH. For example, the UE 904 may monitor the control channel for control information (for example, DCI) pertaining to the UE 904. If the UE 904 does not detect and/or successfully decode any control channel communications addressed to the UE 904 during the DRX on duration 908, then the UE 904 may enter the sleep state 910 (for example, for the inactive time period) at the end 914 of the DRX on duration 908. In this way, the UE 904 may conserve battery power and/or reduce power consumption. As shown, the DRX cycle 906 may repeat with a configured periodicity according to the DRX configuration.

If the UE 904 detects and/or successfully decodes a control channel communication 912 addressed to the UE 904, then the UE 904 may remain in an active state (for example, awake) for the duration of a DRX inactivity timer 916 (for example, which may extend into the configured inactive time period of the current DRX cycle). The DRX inactivity timer 916 may be referred to herein as a timer parameter. The time period 918 depicts the extension of the active time period due to the DRX inactivity timer 916 being initiated. The UE 904 may start the DRX inactivity timer 916 at a time at which the control channel communication is received (for example, in a transmission-time-interval in which the control channel communication 912 is received, such as symbol, a slot, or a subframe). The UE 904 may remain in the active state until the DRX inactivity timer 916 expires, at which time the UE 904 may enter the sleep state 910 (for example, for the remainder of the inactive time period of the current DRX cycle). During the duration of the DRX inactivity timer 916, the UE 904 may continue to monitor for control channel communications, may obtain a downlink data communication (for example, on a data channel such as a PDSCH) scheduled by the control channel communication, and/or may prepare and/or transmit a communication (for example, on a PUSCH and/or a PSSCH) scheduled by the control channel communication. The UE 904 may restart the DRX inactivity timer 916 after each detection of a control channel communication for the UE 904 for an initial transmission (for example, but not, in some cases, for a retransmission). By operating in this manner, the UE 904 may conserve battery power and reduce power consumption by entering the sleep state 910.

FIGS. 10A and 10B depict various example aspects of DRX configurations. For example, FIG. 10A depicts an example of a DRX configuration 1000 with WUSs and FIG. 10B depicts an example of a configuration 1002 for a WUS. In some aspects, the DRX configuration 1000 and the configuration 1002 for a WUS may implement aspects of or may be implemented by aspects of FIGS. 1-9. For example, as described herein, a device (e.g., UE 104, UE 304, UE 504, UE 804, or similar terminal device as described with reference to FIGS. 1-3 and 5-9) may be configured for DRX operations (e.g., periodically alternate between an active mode during DRX-on durations and an inactive mode) for communications with a network entity (e.g., e.g., BS 102, network entity 502, base station, or similar network entity as described with reference to FIGS. 1-3 and 5-9), where the DRX operations are performed based on the DRX configuration 1000 and the configuration 1002 for a WUS.

In some aspects and as illustrated in the example of FIG. 10A, the device may be configured with DRX operations based on the DRX configuration 1000 and may be configured to monitor for a WUS in a set of WUS monitoring instances 1004 outside of one or more DRX-on durations 1006 (e.g., DRX active time(s)). For example, a set of WUS monitoring instances 1004 may be associated with DRX-on durations 1006, where the DRX-on durations 1006 are part of respective DRX cycles 1008. For example, a first set of WUS monitoring instances 1004A may be associated with a first DRX-on duration 1006A, and the first DRX on-duration 1006A is part of a DRX cycle 1008. Additionally, a second set of WUS monitoring instances 1004B may be associated with a second DRX-on duration 1006B and a second DRX cycle (e.g., not illustrated in the example of FIG. 10A).

A WUS may indicate whether a MAC entity for the device should start a DRX-on duration timer (e.g., drx-onDurationTimer) for a next DRX-on duration of a DRX cycle. For example, a WUS received and decoded in the first set of WUS monitoring instances 1004A may indicate whether the device (e.g., MAC entity of the device) should start the DRX-on duration timer for the first DRX-on duration 1006A. Additionally, the WUS may not impact other timers for the device (e.g., bwp-inactivityTimer, dataInactivityTimer, sCellDeactivationTimer, etc.)

In some aspects, the WUS may be a PDCCH defined by a DCI format 2_6 with a cyclic redundancy check (CRC) scrambled by a power saving radio network temporary identifier (PS-RNTI). Additionally, a WUS may be shared by a group of devices and may be monitored in common search space set sets (e.g., the sets of WUS monitoring instances 1004). In some aspects, a WUS may be configured on a primary cell (PCell) and/or a primary secondary cell (PSCell). Additionally, a WUS may indicate dormancy behavior for (up to five) secondary cell (SCell) groups.

In some aspects, the DRX cycle 1008 may include a DRX active time 1022, a DRX inactive time 1024, and a DRX-off duration 1026. For example, the DRX active time 1022 may correspond to the first DRX-on duration 1006A based on the device detecting and receiving a WUS in the first set of WUS monitoring instances 1004A, where the WUS indicates for the device to start the DRX-on duration timer. After the DRX-on duration timer expires, the device may enter the DRX inactive time 1024, where the device runs a DRX inactivity timer and may start or restart the DRX inactivity timer each time a downlink channel is detected and received that indicates an uplink or downlink transmission for the device. Subsequently, the device may stay in an active state to monitor for downlink channels until the DRX inactivity timer expires. In some aspects, after the DRX inactivity timer expires, the device may then enter into the DRX-off duration 1026, where the device powers down one or more RF elements to conserve battery power. Additionally or alternatively, during the DRX-off duration 1026, the device may still monitor for and receive WUSs for subsequent DRX cycles, such as during the second set of WUS monitoring instances 1004B.

In the example of FIG. 10B, the configuration 1002 for a WUS may include one or more device-specific fields 1014 that include a corresponding wake-up indication bit 1010 and corresponding content fields 1012 (e.g., sequence of reserved bits). For example, a first device-specific field 1014A may include a first wake-up indication bit 1010A and a first content field 1012A, a second device-specific field 1014B may include a second wake-up indication bit 1010B and a second content field 1012B, etc., up to an n-th device-specific field that includes an n-th wake-up indication bit 1010C and an n-th content field 1012C. The one or more device-specific fields may be considered as a payload size 1016 for the WUS. Additionally, the configuration 1002 of the WUS may include a CRC 1018.

In some aspects, the location of the wake-up indication bits 1010 in the payload size 1016 of the WUS may indicate a position of the device-specific fields 1014. For example, the location of the wake-up indication bits 1010, such as the time-frequency resources on which the wake-up indication bits 1010 are transmitted within the payload size 1016, may represent a start of each device-specific field 1014. Additionally, the WUS (e.g., PDCCH-WUS, DCI format 2_6, etc.) can be shared by a group of devices, and each device in the group can be assigned with a device-specific field 1014 in the DCI. In some aspects, the WUS may be used for SCell groups (e.g., up to five) for a dormancy behavior indication outside active time as described with reference to FIG. 10A. Additionally or alternatively, an indication for SCell groups for dormancy behavior during active time (e.g., by scheduling DCI) may be configured separately.

In some aspects, for monitoring of DCI format 2_6 (e.g., including the WUS), a device may be provided with a PS-RNTI for scrambling the CRC 1018 of the DCI format 2_6. Additionally, the device may be provided with one or more common search spaces (CSSs) (e.g., Type3-PDCCH CSS(s)) for monitoring for the DCI format 2_6 with the PS-RNTI. In some aspects, more than one search space set(s) may be configured for the DCI format 2_6, and associated control resource sets (CORESETs) with the search space sets can have different transmission configuration indicator (TCI) states (e.g., for WUS beam sweeping in a frequency range, such as the frequency range 2 (FR2)).

In some aspects, each device-specific field 1014 may include the wake-up indication bit 1010 and an SCell dormancy bitmap 1020 (e.g., a bitmap indicating one or more SCells for which the wake-up indication bit 1010 applies, where the bitmap is included in the content fields 1012). For example, once a device detects a DCI format 2_6 in a WUS monitoring instance, the device may find an assigned field for itself in the content fields 1012 and/or SCell dormancy bitmap 1020. In some aspects, the SCell dormancy bitmap 1020 may be a configurable size (e.g., 0-5 bits). Table 1 below indicates device behavior based on the wake-up indication bit 1010.

TABLE 1
Device Behavior Based on WUS Indication

| | Indicated Device Behavior | |
|---|---|---|
| | ‘0’ | ‘1’ |
| Wake-Up | Do not start drx- | Start drx-onDurationTimer for |
| Indication Bit | onDurationTimer for the next | the next DRX cycle |
| | DRX cycle | |
| Bitmap for SCell | For each activated SCell in the | For each activated SCell in the |
| Dormancy | corresponding SCell group: | corresponding SCell group: |
| Indication | If the current active | If the current active |
| | bandwidth part (BWP) is a | BWP is a non-dormant BWP, |
| | non-dormant BWP, it switches | it continues with the same |
| | to the dormant-B WP | BWP |
| | If the current active | If the current active |
| | BWP is the dormant BWP, it | BWP is the dormant BWP, it |
| | continues with the dormant | switches to a specific non- |
| | BWP | dormant BWP configured by |
| | | RRC |

Additionally, the device may be provided with a time offset (e.g., ps_Offset) for DRX operations, where the time offset indicates a time that the device starts locating WUS monitoring instances for the DCI format 2_6 prior to a slot where a DRX cycle starts. In some aspects, the time offset may be a value between 0.125 milliseconds (ms) and 15 ms (e.g., ps_Offset ∈{0.125 ms, 0.25 ms, 0.375 ms, . . . , 15 ms})

If a device detects the DCI format 2_6 in at least one WUS monitoring instance (e.g., in one or more monitoring symbols), the device may follow the indication in the device-specific field in the DCI as described in Table 1. Additionally or alternatively, if the device monitors the WUS monitoring instances, but no DCI format 2_6 is detected (e.g., discontinuous transmission (DTX) from a network entity and/or misdetection at the device), then a higher layer parameter (e.g., ps-Wakeup-r16 or ps-WakeupOrNot) may indicate whether or not the device is to start the on duration timer for a next DRX cycle. If the higher layer parameter is not provided, the device may not start the on duration timer for the next DRX cycle.

If both short and long DRX cycles are configured for the device, the device may monitor for the DCI format 2_6 for the long DRX cycles. In some aspects, a short DRX cycle may include a first configurable length that is shorter than a second configurable length for long DRX cycles. For example, the short DRX cycles may span a first number of subframes, and the long DRX cycles may span a second number of subframes, where the first number of subframes is less than the second number of subframes. For DRX short cycles, the device may always start the on duration timer for the DRX short cycles. In some aspects, the device may not be required to monitor for the DCI format 2_6 during DRX active time.

In some aspects, the device may start the on duration timer for the next DRX cycle if any of the following is true: a current active BWP is not configured to monitor for the DCI format 2_6; the device is not required to monitor a PDCCH for detection of the DCI format 2_6 (e.g., due to overlap with SSBs, other PDCCH occasions with different quasi-colocation (QCL)-TypeD properties, measurement gap, BWP switching delay, etc.) for all WUS monitoring instances; and/or there are no WUS monitoring instances for a DRX cycle.

In some aspects, the device may or may not perform one or more background activities with DRX. For example, if DRX operations is configured, a corresponding device may not be required to perform radio resource management (RRM) measurement(s) other than during the DRX active time. If a DRX cycle is longer than a threshold (e.g., larger than 80 ms), then the device may not expect CSI-RS resources for mobility are available other than during the DRX active time. Additionally or alternatively, for CSI measurement and reporting, if DRX is configured, then the corresponding device may not be required to measure CSI other than during the DRX active time, and the device may not report CSI on a PUCCH (e.g., periodic/semi-periodic CSI report) other than during DRX active time.

In some aspects, if the on duration timer is not triggered by the DCI format 2_6 (e.g., due to lack of downlink traffic), then the device may be kept outside the DRX active time for a long duration (e.g., dozens of seconds). As such, the device may not perform RRM measurement(s) outside active time, and the mobility performance for the device may be degraded. Additionally, the device may not perform CSI measurement and reporting outside active time, and the link performance may be degraded or the beam-paired link may fail.

Table 2 indicates time-domain states associated with DRX operations:

TABLE 2
Time-Domain States for DRX Operations

| States | Conditions |
|---|---|
| DRX Active Time | drx-onDurationTimer, drx-InactivityTimer, drx- |
| | RetransmissionTimerDL/UL, or ra- |
| | ContentionResolutionTimer is running |
| Outside Active Time | Time duration other than the DRX Active Time |
| Configured DRX- | Outside DRX Active Time |
| On Duration Outside | During the time duration configured for drx- |
| Active Time | onDurationTimer, when the drx-onDurationTimer is not |
| | triggered by DCI format 2_6 |

In some aspects, a device may perform RRM measurement(s) during a configured DRX-on duration outside the DRX active time, and CSI-RS resources for mobility may be available during the configured DRX-on duration outside the DRX active time. Additionally or alternatively, the device can perform CSI measurement and periodic CSI reporting during a configured DRX-on duration. In some aspects, a higher layer parameter (e.g., PS_Periodic_CSI_TransmitOrNot) may enable or disable periodic CSI reporting for the device (e.g., other than L1-RSRP reporting) during the configured DRX-on duration. Additionally or alternatively, another higher layer parameter (e.g., PS_Periodic_L1-RSRP_TransmitOrNot) may enable or disable periodic L1-RSRP reporting for beam management.

FIG. 11 depicts an example of a communications system 1100 implementing DRX operations. In some aspects, the communications system 1100 may implement aspects of or may be implemented by aspects of FIGS. 1-10B. For example, the communications system 1100 may include a network entity 1102, a first device 1104A, and a second device 1104B. The network entity 1102 may represent a base station or similar network entity as described with reference to FIGS. 1-3 and 5-10B (e.g., BS 102, BS 180, network entity 502, etc.). The device 1104A and the device 1104B may represent UEs or similar terminal devices as described with reference to FIGS. 1-3 and 5-10B (e.g., UE 104, UE 504, UE 804, etc.).

Additionally, in the example of FIG. 11, the device 1104A and the device 1104B may be configured for DRX operations (e.g., periodically alternate between an active mode during DRX-on durations and an inactive mode). In some aspects, the device 1104A and the device 1104B may also be configured to monitor a WUS outside DRX active time to indicate whether the device 1104A and/or the device 1104B can continue to sleep during a corresponding DRX-on duration (e.g., if there is no data for the device 1104A and/or the device 1104B) or if the device 1104A and/or the device 1104B should wake up to receive data during the corresponding DRX-on duration.

In some aspects, the communications system 1100 may represent CSI measurement and reporting for the device 1104A and the device 1104B when WUS is configured. Additionally, the device 1104A and the device 1104B may be provided with a higher layer parameter that enables or disables periodic CSI reporting during a configured DRX-on duration the for respective devices (e.g., PS_Periodic_CSI_TransmitOrNot). In the example of FIG. 11, the device 1104A may be disabled from transmitting periodic CSI reports during the configured DRX-on duration (e.g., PS_Periodic_CSI_TransmitOrNot=‘disable’), and the device 1104B may be enabled to transmit periodic CSI reports during the configured DRX-on duration (e.g., PS_Periodic_CSI_TransmitOrNot=‘enable’).

In the example of FIG. 11, the network entity 1102 may transmit a plurality of CSI-RSs 1106 (e.g., periodically), where the device 1104A and the device 1104B are configured to send one or more CSI reports 1108 (e.g., periodic CSI reports) for the CSI-RSs 1106 based on whether a WUS 1110 (e.g., DCI format 2_6) is received or not and based on the higher layer parameter. For example, the network entity 1102 may send the WUS 1110 prior to a DRX active time 1112 for a DRX cycle 1114, where the WUS 1110 indicates for the device 1104A and the device 1104B to start a DRX-on duration timer for the DRX active time 1112. In some aspects, the DRX cycle 1114 may include a DRX active time 1124, a DRX inactive time 1126, and a DRX-off duration 1128. The DRX active time 1124 may correspond to the DRX active time 1022 as described with reference to FIG. 10A, the DRX inactive time 1126 may correspond to the DRX inactive time 1024 as described with reference to FIG. 10A, and the DRX-off duration 1128 corresponds to the DRX-off duration 1026 as described with reference to FIG. 10A.

Subsequently, based on detecting and receiving the WUS 1110, the device 1104A and the device 1104B may perform one or more measurements 1116 during the DRX active time 1112 of the CSI-RS(s) 1106 transmitted by the network entity 1102. Subsequently, the device 1104A may send one or more CSI reports 1108A during the DRX active time 1112 based on the one or more measurements 1116, and the device 1104B may send one or more CSI reports 1108B during the DRX active time 1112 based on the one or more measurements 1116. In some aspects, the device 1104A and the device 1104B may refrain from performing any measurements at one or more time points 1118 of CSI-RS 1106 outside of the DRX active time 1112.

In some aspects, during a WUS monitoring instance 1120, the network entity 1102 may refrain from sending a WUS to the device 1104A and the device 1104B. Even though no WUS is sent, a time duration 1122 may be indicated by DR X-on duration timer, but the time duration 1122 is not a DRX active time. As such, based on not receiving the WUS and being disabled from transmitting periodic CSI reports during the configured DRX-on duration, the device 1104A may not send any CSI reports during the time duration 1122. Additionally or alternatively, based on being enabled to transmit periodic CSI reports during the configured DRX-on duration, the device 1104B may perform one or more measurements 1116 of the CSI-RS(s) 1106 transmitted by the network entity 1102 and may send one or more CSI reports 1108B during the time duration 1122.

### Aspects Related to CSI Measurement and Prediction Cycles for DRX

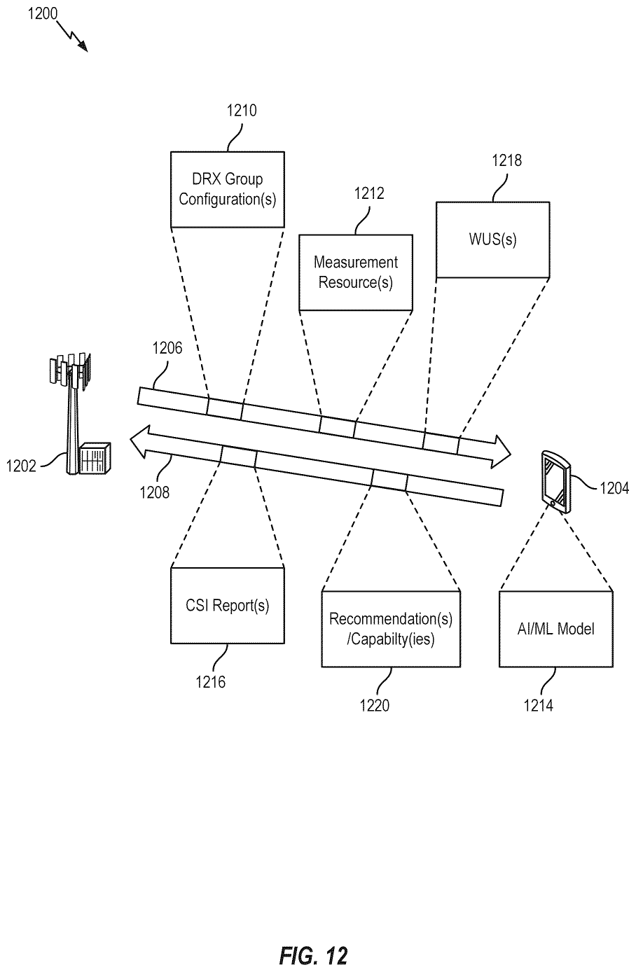

FIG. 12 depicts an example wireless communications network 1200 that supports CSI measurement and prediction cycles for DRX in accordance with aspects of the present disclosure. In some examples, the wireless communications network 1200 may implement aspects of or may be implemented by aspects of FIGS. 1-11 For example, the wireless communications network 1200 may include communications between a network entity 1202 and a UE 1204. The network entity 1202 may be an example of the BS 102 depicted and described with respect to FIG. 1 the first network entity 300 or the second network entity 302 depicted and described with respect to FIG. 3, a disaggregated base station depicted and described with respect to FIG. 2 the network entity 502 depicted and described with respect to FIG. 5, the second wireless device 704 depicted and described with respect to FIG. 7, the network node 802 depicted and described with respect to FIG. 8, the network entity 902 depicted and described with respect to FIG. 9, the network entity described with respect to FIGS. 10A and 10B, or the network entity 1102 depicted and described with respect to FIG. 11 The UE 1204 may be an example of the UE 104 depicted and described with respect to FIG. 1 the UE 304 depicted and described with respect to FIG. 3, the UE 504 depicted and described with respect to FIG. 5, the UE described with respect to FIG. 6, the first wireless device 702 depicted and described with respect to FIG. 7, the UE 804 depicted and described with respect to FIG. 8, the UE 904 depicted and described with respect to FIG. 9, the UE described with respect to FIGS. 10A and 10B, or the UEs 1104 depicted and described with respect to FIG. 11.

Additionally, the wireless communications network 1200 may be an example of wireless communications network 100 and may support communication between the network entity 1202 and the UE 1204. For example, the network entity 1202 and the UE 1204 may wirelessly communicate via a first communication link 1206 (e.g., a downlink communication link, one or more carriers, a communication link 120, etc.) and a second communication link 1208 (e.g., an uplink communication link, one or more carriers, a communication link 120, etc.). The UE 1204 may be configured for DRX operations (e.g., C-DRX mode) as depicted and described with respect to FIGS. 9-11.

As described herein, during DRX operation, the UE 1204 may be configured to measure CSI (e.g., as depicted and described with respect to FIGS. 5 and 11) on a first group of DRX-on cycles and to predict CSI (e.g., via an AI/ML model as depicted and described with respect to FIGS. 6-8) on a second group of DRX-on cycles. In some aspects, the first group of DRX-on cycles may be configured for CSI measurements. For example, the UE 1204 may be expected to perform and report CSI measurements for channel and/or interference measurement resources (e.g., CSI measurement resources, such as SSBs, CSI-RSs, CSI-IM resources, etc.) that are configured to occur during the first group of DRX-on cycles. In some aspects, and the second group of DRX-on cycles may be configured for CSI predictions. For example, the UE 1204 may be expected to perform CSI predictions for channel and/or interference measurement resources (e.g., CSI measurement resources, such as SSBs, CSI-RSs, CSI-IM resources, etc.) that are configured to occur during the second group of DRX-on cycles.

In some aspects, the first group of DRX-on cycles may be referred to as measurement DRX-on cycles, and the second group of DRX-on cycles may be referred to as prediction DRX-on cycles. In some aspects, the measurement DRX-on cycles may include activated DRX-on cycles, and the prediction DRX-on cycles may include deactivated DRX-on cycles. By relying on CSI prediction, the UE 1204 may skip waking up during the second group of DRX-ON cycles and, thus, may achieve energy savings. Additionally or alternatively, the network entity 1202 may obtain continuous CSI updates from the UE 1204 about the measured CSI for the first group of DRX-on cycles and the predicted CSI for the second group of DRX-on cycles, which may enable the network entity 1202 to maintain improved link quality, beam management, scheduling, and resource allocation for the UE 1204.

In some aspects, during DRX operation, the network entity 1202 may send signaling 1210 to the UE 1204 (e.g., via the first communication link 1206) that configures the UE 1204 with measurement DRX-on cycles (e.g., the first group of DRX-on cycles and/or one or more first DRX-on cycles) and prediction DRX-on cycles (e.g., the second group of DRX-on cycles and/or one or more second DRX-on cycles). For example, the UE 1204 may be configured to measure CSI using one or more channel and/or interference measurement resources 1212 (e.g., SSB(s), CSI-RS(s), CSI-IM resource(s), etc.) obtained during the measurement DRX-on cycles and to predict CSI during the prediction DRX-on cycles. In some aspects, the UE 1204 may predict CSI during the prediction DRX-on cycles based on an AI/ML model 1214 loaded onto or otherwise accessible by the UE 1204. Subsequently, the UE 1204 may send one or more CSI reports 1216 to the network entity 1202 (e.g., via the second communication link 1208) to report the measured CSI and the predicted CSI.

In some aspects, the network entity 1202 may configure the UE 1204 with two DRX groups (e.g., C-DRX cycle groups) via the signaling 1210. For example, the two DRX groups may include a first DRX group for the measurement DRX-on cycles and a second DRX group for the prediction DRX-on cycles, such that the first DRX group may be referred to as a measurement DRX group and the second DRX group may be referred to as a prediction DRX group. In some aspects, each DRX group may include separated DRX cycles and timers configured by the network entity 1202 via the signaling 1210. For example, each DRX group may include a separate drx-onDurationTimer, drx-InactivityTimer, drx-LongCycleStartOffset, etc., that the network entity 1202 configures via the signaling 1210.

Additionally or alternatively, the prediction DRX group may be associated with the measurement DRX group. For example, the prediction DRX group may have separate DRX cycles from the measurement DRX group. However, the prediction DRX group may include one or more same DRX parameters from the measurement DR X cycles group. For example, the prediction DRX group may use one or more same timers as the measurement DRX group, such as a common (e.g., same) drx-onDurationTimer, drx-InactivityTimer, etc. In some aspects, the network entity 1202 may configure (e.g., via the signaling 1210) all DRX parameters and timers for the measurement DR X group and may configure a subset of the DRX parameters and timers for the prediction DRX group, such that any DRX parameters and timers not configured for the prediction DRX group may be determined from the measurement DRX group configuration.

However, the prediction DRX group may be associated with its own DRX cycle (e.g., drx-Cycle). In some aspects, the DRX cycle of the prediction DRX group may have a shorter periodicity compared to the DRX cycle of the measurement DRX group. In some aspects, a periodicity of the DRX cycle of the prediction DRX group may be a multiple integer of the periodicity of the DRX cycle of the measurement DR X group. For example, the periodicity of the DRX cycle of the prediction DRX group may correspond to a multiple integer (e.g., 2, 3, 4, etc.) number of prediction DRX-on cycles for each measurement DRX-on cycle.

Additionally or alternatively, the network entity 1202 may configure the UE 1204 with a single DRX group via the signaling 1210 to indicate the measurement DRX-on cycles and the prediction DRX-on cycles. In some aspects, an additional parameter may be included in the configuration of the single DRX group (e.g., DRX cycle configuration) to indicate a number and/or ratio (e.g., amount) of prediction DRX-on cycles for each measurement DRX-on cycle. For example, the additional parameter may indicate that for each measurement DRX-on cycle, the UE 1204 may be expected and/or configured to predict CSI for a multiple integer (e.g., 2, 3, 4, etc.) number of prediction DRX-on cycles after the measurement DRX-on cycle. Additionally or alternatively, the network entity 1202 may indicate the measurement DRX-on cycles and the prediction DRX-on cycles using the single DRX group. For example, during a measurement DRX-on cycle (e.g., configured by the single DRX group), the network entity 1202 may indicate that a next DRX-on cycle after the measurement DRX-on cycle is configured to be a prediction DRX-on cycle. Additionally or alternatively, during the measurement DRX-on cycle, the network entity 1202 may indicate if one or more next DRX-on cycles are configured to be measurement DRX-on cycle(s) or prediction DRX-on cycle(s).

Additionally or alternatively, the network entity 1202 may indicate an index of the measurement DRX-on cycles and the prediction DRX-on cycles (e.g., the prediction DRX-on cycles may include cycle numbers and/or index values of ‘1,’ ‘2,’ or ‘3’). For example, each DRX-on cycle (e.g., DRX-on duration) may include an index value, and, subsequently, based on the index value(s), the network entity 1202 may configure the measurement DRX-on cycles and the prediction DRX-on cycles. In some aspects, the index values may start counting after the start of signaling that indicates the DRX configuration(s) for the measurement DRX-on cycles and the prediction DRX-on cycles (e.g., after the signaling 1210). For example, a first DRX-on cycle after the signaling 1210 (e.g., that indicates the DRX configuration(s)) may include an index value of ‘1,’ a second DRX-on cycle after the signaling 1210 may include an index value of ‘2,’ etc., and the index values may reset after additional DRX configuration(s) and/or signaling is communicated by the network entity 1202. Accordingly, the network entity 1202 may configure and/or indicate which DRX-on durations are configured for the measurement DRX-on durations and for the prediction DRX-on durations by signaling corresponding index value(s) for each type of DRX-on duration. For example, in the signaling 1210, the network entity 1202 may indicate which index value(s) correspond to measurement DRX-on cycle(s) and/or which index value(s) correspond to prediction DRX-on cycle(s). Additionally or alternatively, in a specific measurement DRX-on cycle, the network entity 1202 may indicate which index value(s) of DRX-on cycles after the specific measurement DRX-on cycle correspond to prediction DRX-on cycles.

Alternatively, the index values may restart counting after each measurement DRX-on cycle. For example, a first DRX-on cycle after a given measurement DRX-on cycle includes an index value of ‘1,’ a second DRX-on cycle after the given measurement DRX-on cycle includes an index value of ‘2,’ etc., and the index values may reset after another measurement DRX-on cycle occurs. As an example, the network entity 1202 may configure and/or indicate to the UE 1204 (e.g., via the signaling 1210 and/or in a corresponding measurement DRX-on cycle) that, after each measurement DRX-on cycle, the next two DRX-on cycles (e.g., corresponding to index values ‘1’ and ‘2’ based on the index values restarting their counting after each measurement DRX-on cycle) are prediction DRX-on cycles. As another example, during a specific measurement DRX-on cycle, the network entity 1202 may configure the UE 1204 to predict the CSI for DRX-on cycles with index values of ‘1’ and ‘3’ (e.g., a first and third DRX-on cycle after the specific measurement DRX-on cycle are configured as prediction DRX-on cycles and for CSI prediction), such that the UE 1204 is not configured to predict CSI for a DRX-on cycle with the index value of ‘2’ (e.g., a second DRX-on cycle after the specific measurement DRX-on cycle). In some aspects, these index values may give flexibility to the network entity 1202 to configure the measurement DRX-on cycles and the prediction DRX-on cycles.

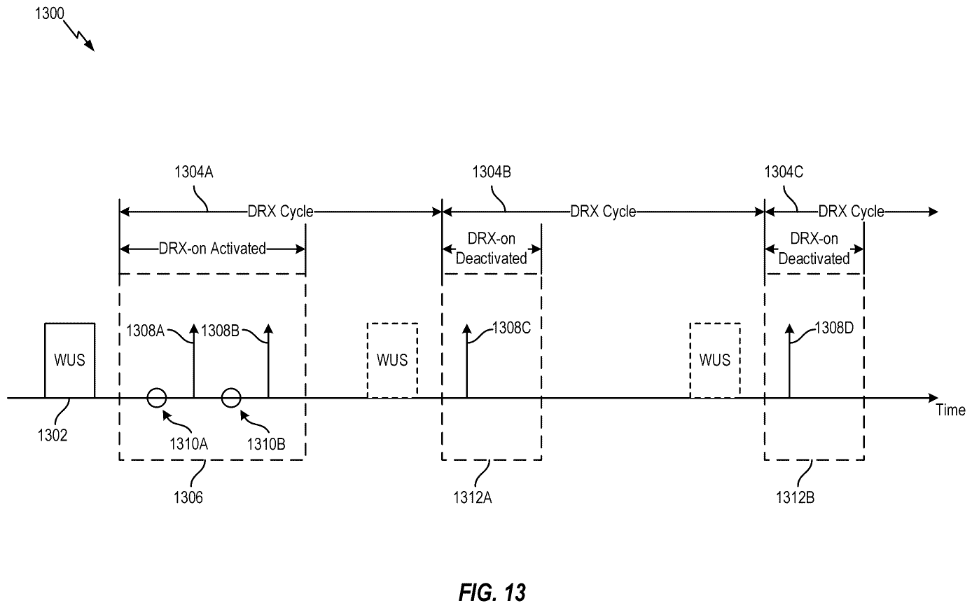

In some aspects, the UE 1204 may determine the measurement DRX-on cycles and the prediction DRX-on cycles based on one or more WUSs 1218. For example, when the UE 1204 receives a WUS 1218 (e.g., through DCI format 2_6), the UE 1204 may be triggered to measure CSI in a next DRX-on cycle after the WUS 1218, such that the next DRX-on cycle is configured and/or referred to as a measurement DRX-on cycle. Additionally, the UE 1204 may also be triggered to predict CSI on one or more following DRX-on cycles after that next DRX-on cycle (e.g., after the WUS 1218), such that the one or more following DRX-on cycles are configured and/or referred to as prediction DRX-on cycles. In some aspects, the number of prediction DRX-on cycles after the measurement DRX-on cycle may be configured by the network entity 1202 or may be defined in wireless communications standards. In some aspects, the network entity 1202 may configure the UE 1204 to enable or disable CSI prediction on future DRX-on cycles based on a WUS 1218. The configuration of measurement DRX-on cycle(s) and prediction DRX-on cycle(s) based on one or more WUSs 1218 is depicted and described in greater detail with respect to FIG. 13.

In some aspects, the UE 1204 may be configured to report the predicted CSI for prediction DRX-on cycles via a CSI report 1216 sent during measurement DRX-on cycle(s). That is, the UE 1204 may be configured to predict CSI for one or more prediction DRX-on cycles after a given measurement DRX-on cycle and may send the CSI report 1216 to report the predicted CSI for the one or more prediction DRX-on cycles during the measurement DRX-on cycle, where the CSI report 1216 also includes measured CSI for the measurement DRX-on cycle. For example, the UE 1204 may multiplex predicted CSI for future DRX-on cycles (e.g., the prediction DRX-on cycles) with measured CSI in a single CSI report during a current DRX-on cycle (e.g., a measurement DRX-on cycle). Additionally or alternatively, the UE 1204 may be configured to report the predicted CSI during prediction DRX-ON cycles. That is, the UE 1204 may be configured to predict first CSI for a first prediction DRX-on cycle and report the predicted first CSI in a first CSI report during the first prediction DRX-on cycle, predict second CSI for a second prediction DRX-on cycle and report the second predicted CSI in a second CSI report during the second prediction DRX-on cycle, etc. In either of the options described above, the UE 1204 may report measured CSI in a CSI report during a given measurement DRX-on cycle, where the CSI is measured based on channel and/or interference measurement resources 1212 obtained during the given measurement DRX-on cycle.

In some aspects, the UE 1204 may be configured to report the predicted CSI for a first periodic channel and/or interference measurement resource 1212 (e.g., CSI-RS, SSB, CSI-IM, etc.) expected to be communicated in the prediction DRX-on cycle(s). Additionally or alternatively, the UE 1204 may be configured to report the predicted CSI for all periodic channel and/or interference measurement resources 1212 within an on-duration timer (e.g., drx-onDurationTimer) in the prediction DRX-on cycle(s). Additionally or alternatively, the UE 1204 may be configured to report the predicted CSI for a subset of periodic channel and/or interference measurement resources 1212 within the on-duration timer in the prediction DRX-on cycle(s). In some aspects, a number (e.g., amount) of measurement resources for the subset of periodic channel and/or interference measurement resources 1212 for CSI prediction may be configured by the network entity 1202 or may be predefined in wireless communications standards.

In some aspects, the different configurations signaled by the network entity 1202 described above may be performed through RRC signaling, MAC control element (CE), or DCI. Additionally, the CSI measurements and/or CSI predictions from the UE 1204 may be performed through RRC signaling, MAC-CE, or UCI. Additionally, CSI prediction, as used herein, may include or imply a prediction of any of: channel measurement, interference measurement, CSI-RS resource indicator (CRI), SSB resource indicator (SSBRI), RSRP, SINR, CQI, PMI, RI, MCS, etc.

In some aspects, the UE 1204 may send a message 1220 to the network entity 1202 to indicate one or more recommendations and/or one or more capabilities of the UE 1204 for the CSI prediction. For example, the message 1220 may include a recommendation message, where the UE 1204 reports one or more of: a recommendation of whether to predict the CSI for future DRX-on cycles or not, a recommendation number and indices of future DRX-on cycles to predict the CSI on, a recommendation on prediction DRX cycle group parameters and timers (e.g., drx-onDurationTimer, drx-InactivityTimer, drx-LongCycleStartOffset, etc.), a recommendation on whether to perform cross-frequency or spatial (e.g., cross-beam) CSI prediction for future DRX-on cycles, and/or a recommendation on the CSI information (e.g., CQI, PMI, RI, SINR, etc.) to predict on future DRX-on cycles. Additionally or alternatively, the message 1220 may include a capability message, where the UE 1204 reports one or more of: a capability of whether the UE 1204 supports CSI prediction for future DRX-on cycles, a capability for a number of future DRX-on cycles the UE 1204 supports for CSI prediction, a capability on prediction DRX cycle group parameters and timers (e.g., drx-onDurationTimer, drx-InactivityTimer, drx-LongCycleStartOffset, etc.), a capability on whether the UE 1204 supports cross-frequency or spatial CSI prediction on future DRX cycles, and/or a capability on the CSI information types the UE 1204 can predict on future DRX-on cycles. In some aspects, the recommendation message and the capability message may be two different messages.

In some aspects, the network entity 1202 may use the information from the message 1220 (e.g., the recommendations and/or the capabilities) when configuring the UE 1204 to perform and report the CSI predictions as described herein.

FIG. 13 depicts an example timeline 1300 for DRX communications. In some aspects, the timeline 1300 may implement aspects of or may be implemented by aspects of FIGS. 1-12 For example, based on the timeline 1300, a UE may measure CSI and predict CSI as described with respect to FIG. 12 In some aspects, the UE may determine measurement DRX-on cycles and prediction DRX-on cycles based on obtaining a WUS 1302.

In the example of FIG. 13, the UE may obtain the WUS 1302 from a network entity, where the WUS 1302 indicates for the UE to start an on-duration timer for a first DRX cycle 1304A. Accordingly, the WUS 1302 may trigger the UE to measure and report measured CSI in the first DRX cycle 1304A (e.g., a measurement DRX-on cycle), such as during a DRX-on duration 1306 (e.g., an activated DRX-on duration during the first DRX cycle 1304A, where the DRX-on duration 1306 is considered activated based on the UE obtaining the WUS 1302). In some aspects, the first DRX cycle 1304A and the DRX-on duration 1306 may be configured for CSI measurement as described herein. For example, the UE may obtain one or more channel and/or interference measurement resources 1308 (e.g., SSB(s), CSI-RS(s), CSI-IM resource(s), etc.) during the DRX-on duration 1306, such as a first channel and/or interference measurement resource 1308A and a second channel and/or interference measurement resource 1308B. Subsequently, the UE may be configured to perform measurements on the first channel and/or interference measurement resource 1308A and/or the second channel and/or interference measurement resource 1308B and may report the measurements during one or more CSI reporting occasions 1310. For example, the UE may report the measurements via a CSI report in a first CSI reporting occasion 1310A and/or in a second CSI reporting occasion 1310B.

Additionally, based on the WUS 1302, the UE may be triggered to predict CSI for one or more DRX-on cycles after the first DRX cycle 1304A. For example, the UE may be triggered to predict CSI for a first DRX-on duration 1312A and for a second DRX-on duration 1312B. In some aspects, the first DRX-on duration 1312A may include a deactivated DRX-on duration for a second DRX cycle 1304B (e.g., a first prediction DRX-on cycle), and the second DRX-on duration 1312B may include a deactivated DRX-on duration for a third DRX cycle 1304C (e.g., a second prediction DRX-on cycle). The DRX-on durations 1312 may include deactivated DRX-on durations for the respective DRX cycles 1304 based on the network entity not sending a WUS prior to those respective DRX cycles 1304.

In some aspects, the second DRX cycle 1304B, the third DRX cycle 1304C, and the corresponding DRX-on durations 1312 may be configured for CSI prediction. For example, the UE may be configured to predict the CSI for the first DRX-on duration 1312A based on a third channel and/or interference measurement resource 1308C that is expected to be communicated or is configured to occur during the first DRX-on duration 1312A. Similarly, the UE may be configured to predict the CSI for the second DRX-on duration 1312B based on a fourth channel and/or interference measurement resource 1308D that is expected to be communicated or is configured to occur during the second DRX-on duration 1312B. In some aspects, the third channel and/or interference measurement resource 1308C and the fourth channel and/or interference measurement resource 1308D may be a first occurring periodic channel and/or interference measurement resource in each DRX-on duration 1312. Additionally or alternatively, the UE may be configured to predict CSI for all periodic channel and/or interference measurement resource(s) or a subset of the periodic channel and/or interference measurement resource(s) expected to be communicated within an on-duration timer in each DRX-on duration 1312.

Subsequently, as shown in the example of FIG. 13, the UE may report the CSI predictions during the DRX-on duration 1306 (e.g., using at least one of the CSI reporting occasions 1310). That is, the UE may report CSI predications for the third channel and/or interference measurement resource 1308C and the fourth channel and/or interference measurement resource 1308D during the DRX-on duration 1306. Alternatively, although not shown in the example of FIG. 13, each of the DRX-on durations 1312 may include a CSI reporting occasion, and the UE may be configured to report the CSI predictions in the corresponding DRX-on durations 1312. For example, the UE may report CSI predictions based on the third channel and/or interference measurement resource 1308C during the first DRX-on duration 1312A and may report CSI predictions based on the fourth channel and/or interference measurement resource 1308D during the second DRX-on duration 1312B.

### Example Signaling of Channel State Measurement and Prediction Cycles for DRX

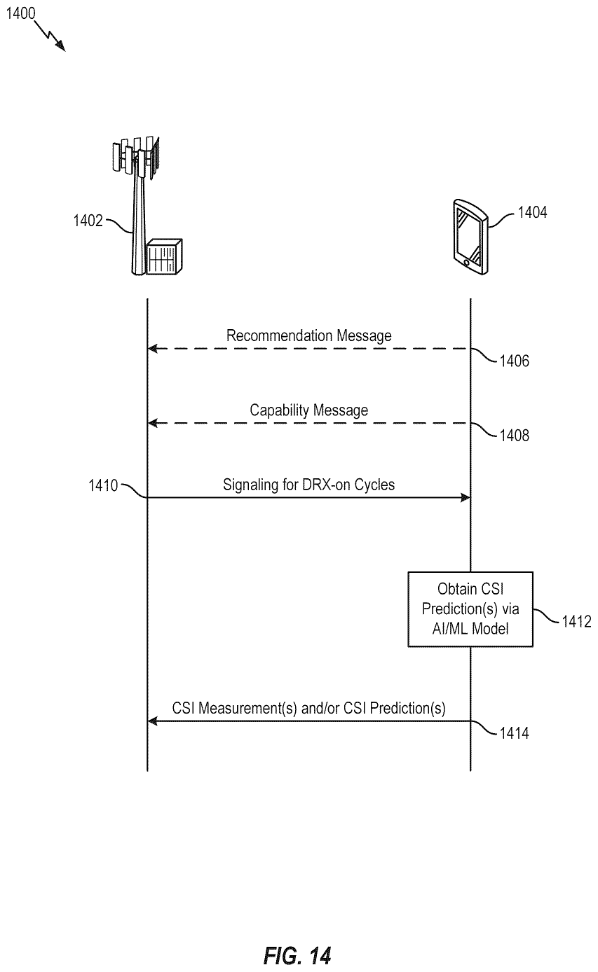

FIG. 14 depicts a process flow 1400 for communications in a network between a network entity 1402 and a UE 1404. In some aspects, the network entity 1402 may be an example of the BS 102 depicted and described with respect to FIG. 1 the first network entity 300 or the second network entity 302 depicted and described with respect to FIG. 3, a disaggregated base station depicted and described with respect to FIG. 2 or the network entity 1202 depicted and described with respect to FIG. 12 Similarly, the UE 1404 may be an example of UE 104 depicted and described with respect to FIG. 1 the UE 304 depicted and described with respect to FIG. 3, or the UE 1204 depicted and described with respect to FIG. 12 However, in other aspects, UE 1404 may be another type of wireless communications device and network entity 1402 may be another type of network entity or network node, such as those described herein. Note that any operations or signaling illustrated with dashed lines may indicate that that operation or signaling is an optional or alternative example.

At 1406, the UE 1404 may send, and the network entity 1402 may obtain, a recommendation message (e.g., the message 1220 depicted and described with respect to FIG. 12) that includes one or more of: a recommendation of the UE 1404 of whether to perform CSI predictions for one or more DRX-on cycles, an indication of the one or more DRX-on cycles for the CSI predictions, parameters for the one or more DRX-on cycles (e.g., DRX cycle group parameters and timers) for the CSI predictions (e.g., one or more second DRX-on cycles), a prediction type for the CSI predictions (e.g., cross-frequency CSI prediction, spatial CSI prediction, cross-beam CSI prediction, etc.) for the one or more DRX-on cycles, or an information type for the CSI predictions (e.g., which CSI information to predict, such as CQI, PMI, RI, SINR, etc.) for the one or more DRX-on cycles.

At 1408, the UE 1404 may send, and the network entity 1402 may obtain, a capability message (e.g., the message 1220 depicted and described with respect to FIG. 12) that includes one or more of: a capability of the UE 1404 to perform CSI predictions, an amount of one or more DRX-on cycles supported for the CSI predictions, parameters (e.g., DRX cycle group parameters and timers) that are supported for the one or more DRX-on cycles for the CSI predictions (e.g., one or more second DRX-on cycles), a prediction type supported by the UE 1404 for the CSI predictions (e.g., cross-frequency CSI prediction, spatial CSI prediction, cross-beam CSI prediction, etc.) for the one or more DRX-on cycles, or an information type supported by the UE 1404 for the CSI predictions (e.g., which CSI information to predict, such as CQI, PMI, RI, SINR, etc.) for the one or more DRX-on cycles.

At 1410, the network entity 1402 sends, and the UE 1404 obtains, signaling (e.g., the signaling 1210 depicted and described with respect to FIG. 12) that indicates one or more first DRX-on cycles and one or more second DRX-on cycles, the one or more first DRX-on cycles configured for CSI measurements and the one or more second DRX-on cycles configured for CSI predictions. For example, the UE 1404 may be configured to perform CSI measurements during the one or more first DRX-on cycles and may be configured to perform CSI predictions during the one or more second DRX-on cycles as described with respect to FIGS. 12 and 13. In some aspects, the one or more first DRX-on cycles configured for CSI measurement may correspond to the measurement DRX-on cycles described herein, and the one or more second DRX-on cycles configured for CSI predictions may correspond to the prediction DRX-on cycles herein. In some aspects, the CSI predictions may include one or more of: channel measurement prediction, interference measurement prediction, CRI prediction, SSBRI prediction, RSRP prediction, SINR prediction, CQI prediction, PMI prediction, RI prediction, MCS prediction, etc.

In some aspects, the network entity 1402 may send, and the UE 1404 may obtain, a first configuration for the one or more first DRX-on cycles and a second configuration for the one or more second DRX-on cycles. For example, the first configuration may include a first set of parameters (e.g., first DRX cycles, first DRX cycle lengths, first DRX cycle periodicity, first DRX timer values, first DRX offset values, etc.) for the one or more first DRX-on cycles, and the second configuration may include a second set of parameters (e.g., second DRX cycles, second DRX cycle lengths, second DRX cycle periodicity, second DRX timer values, first DRX offset values, etc.) for the one or more second DRX-on cycles. In some aspects, the first set of parameters may be different than the second set of parameters. Additionally or alternatively, at least one parameter of the first set of parameters may be the same as a parameter of the second set of parameters. For example, the first set of parameters and the second set of parameters may include same DRX timer values, but may include different DRX cycles and/or DRX cycle periodicities. In some aspects, the first configuration may include a first periodicity for the one or more first DRX-on cycles, and the second configuration may include a second periodicity for the one or more second DRX-on cycles, where the second periodicity is shorter than the first periodicity. In some aspects, the second periodicity may correspond to a multiple integer amount of cycles for the one or more second DRX-on cycles for each cycle of the one or more first DRX-on cycles.

Additionally or alternatively, the network entity 1402 may send, and the UE 1404 may obtain, a first configuration for the one or more first DRX-on cycles, where a second configuration for the one or more second DRX-on cycles is based on the first configuration. For example, the first configuration may include a parameter to indicate an amount of cycles for the one or more second DRX-on cycles for each cycle of the one or more first DRX-on cycles. Additionally or alternatively, the network entity 1402 may send, and the UE 1404 may obtain, during a first DRX-on cycle of the one or more first DRX-on cycles, an indication that a next occurring DRX-on cycle after the first DRX-on cycle is configured for the one or more second DRX-on cycles. Additionally or alternatively, the network entity 1402 may send, and the UE 1404 may obtain, during a first DRX-on cycle of the one or more first DRX-on cycles, an indication that one or more next occurring DRX-on cycles after the first DRX-on cycle are configured for the one or more first DRX-on cycles or the one or more second DRX-on cycles. Additionally or alternatively, the network entity 1402 may send, and the UE 1404 may obtain, respective index values for the one or more first DRX-on cycles and/or the one or more second DRX-on cycles (e.g., as described with respect to FIG. 12).

In some aspects, the network entity 1402 may send, and the UE 1404 may obtain, a WUS (e.g., the WUS(s) 1218 depicted and described with respect to FIG. 12), where a first DRX-on cycle after the WUS is configured for the one or more first DRX-on cycles and one or more DRX-on cycles after the first DRX-on cycle are configured for the one or more second DRX-on cycles. In some aspects, the network entity 1402 may send, and the UE 1404 may obtain, an indication of an amount of the one or more DRX-on cycles after the first DRX-on cycle that are configured for the one or more second DRX-on cycles, or the amount of the one or more DRX-on cycles after the first DRX-on cycle that are configured for the one or more second DRX-on cycles may be a pre-defined value. In some aspects, the network entity 1402 may send, and the UE 1404 may obtain, an indication that enables CSI prediction for the one or more second DRX-on cycles based on the WUS.

At 1412, the UE 1404 obtains one or more CSI predictions based on an AI/ML model (e.g., the AI/ML model 1214 depicted and described with respect to FIG. 12). For example, the UE 1404 may obtain the one or more CSI predictions based on the one or more second DRX-on cycles. In some aspects, the CSI predications may be associated with a first measurement resource (e.g., of the one or more channel and/or interference measurement resources 1212 as depicted and described with respect to FIG. 12) configured in each DRX-on cycle of the one or more second DRX-on cycles, a plurality of measurement resources configured in each DRX-on cycle of the one or more second DRX-on cycles, or a subset of the plurality of measurement resources configured in each DRX-on cycle of the one or more second DRX-on cycles. In some aspects, the network entity 1402 may send, and the UE 1404 may obtain, an indication of an amount of the subset of the plurality of measurement resources configured in each DRX-on cycle of the one or more second DRX-on cycles, or the amount of the subset of the plurality of measurement resources configured in each DRX-on cycle of the one or more second DRX-on cycles may be a pre-defined value.

At 1414, the UE 1404 sends, and the network entity 1402 obtains based on the signaling communicated at 1410, at least one of: the CSI measurements or the CSI predictions. In some aspects, the UE 1404 may send, and the network entity 1402 may obtain, the CSI measurements and the CSI predictions in a same CSI measurement report (e.g., CSI report(s) 1216 depicted and described with respect to FIG. 12) during a CSI reporting occasion associated with the one or more first DRX-on cycles. For example, the CSI predictions may be multiplexed with the CSI measurements in the same CSI measurement report. Additionally or alternatively, the UE 1404 may send, and the network entity 1402 may obtain, the CSI measurements during one or more first CSI reporting occasions associated with the one or more first DRX-on cycles (e.g., in one or more first CSI reports) and the CSI predictions during one or more second CSI reporting occasions associated with the one or more second DRX-on cycles (e.g., in one or more second CSI reports).

Note that the process flow illustrated in FIG. 14 is an example of reporting CSI, and aspects of the present disclosure may be applied to predicting CSI. Note that the process flow illustrated in FIG. 14 is described herein to facilitate an understanding of measuring and predicting CSI during DRX operations, and aspects of the present disclosure may be performed in various manners via alternative or additional signaling and/or operations. In certain aspects, the operations and/or signaling of FIG. 14 may occur in an order different from that described or depicted, and various actions, operations, and/or signaling may be added, omitted, or combined.

### Example Operations of a User Equipment

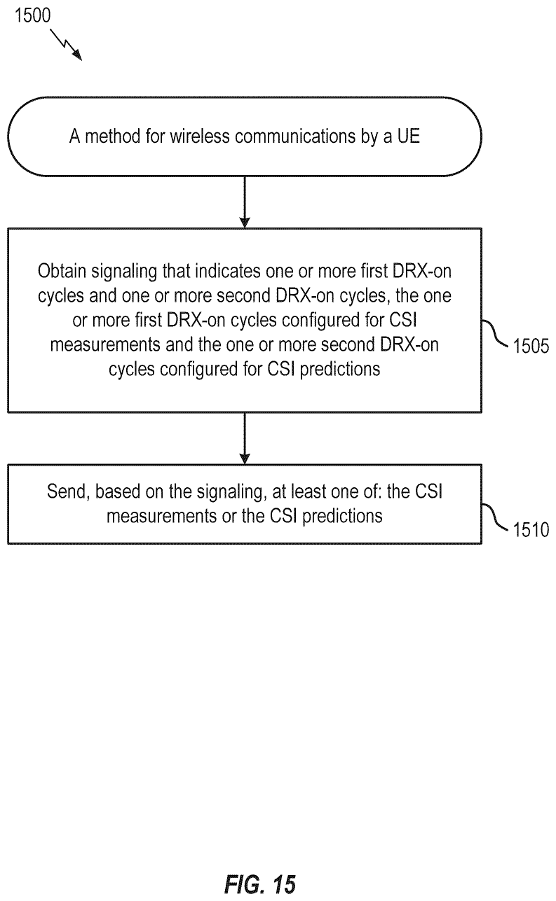

FIG. 15 shows a method 1500 for wireless communications by a UE, such as UE 104 of FIG. 10r UE 304 of FIG. 3.

Method 1500 begins at block 1505 with obtaining signaling (e.g., the signaling 1210 depicted and described with respect to FIG. 12) that indicates one or more first DRX-on cycles and one or more second DRX-on cycles, the one or more first DRX-on cycles configured for CSI measurements and the one or more second DRX-on cycles configured for CSI predictions.

Method 1500 then proceeds to block 1510 with sending (e.g., via the CSI report(s) 1216 depicted and described with respect to FIG. 12), based on the signaling, at least one of: the CSI measurements or the CSI predictions.

In some aspects, block 1505 includes obtaining a first configuration for the one or more first DRX-on cycles and a second configuration for the one or more second DRX-on cycles.

In some aspects, the first configuration comprises a first set of parameters for the one or more first DRX-on cycles and the second configuration comprises a second set of parameters for the one or more second DRX-on cycles, and the first set of parameters is different than the second set of parameters.

In some aspects, the first configuration comprises a first set of parameters for the one or more first DRX-on cycles and the second configuration comprises a second set of parameters for the one or more second DRX-on cycles, and at least one parameter of the first set of parameters is the same as a parameter of the second set of parameters.

In some aspects, the first configuration comprises a first periodicity for the one or more first DRX-on cycles and the second configuration comprises a second periodicity for the one or more second DRX-on cycles, and the second periodicity is shorter than the first periodicity.

In some aspects, the second periodicity corresponds to a multiple integer amount of cycles for the one or more second DRX-on cycles for each cycle of the one or more first DRX-on cycles.

In some aspects, block 1505 includes obtaining a first configuration for the one or more first DRX-on cycles, wherein a second configuration for the one or more second DRX-on cycles is based on the first configuration.

In some aspects, the first configuration comprises a parameter to indicate an amount of cycles for the one or more second DRX-on cycles for each cycle of the one or more first DRX-on cycles.

In some aspects, method 1500 further includes obtaining, during a first DRX-on cycle of the one or more first DRX-on cycles, an indication that a next occurring DRX-on cycle after the first DRX-on cycle is configured for the one or more second DRX-on cycles.

In some aspects, method 1500 further includes obtaining, during a first DRX-on cycle of the one or more first DRX-on cycles, an indication that one or more next occurring DRX-on cycles after the first DRX-on cycle are configured for the one or more first DRX-on cycles or the one or more second DRX-on cycles.

In some aspects, method 1500 further includes obtaining respective index values for the one or more first DRX-on cycles and the one or more second DRX-on cycles.

In some aspects, block 1505 includes obtaining a WUS (e.g., the WU S(s) 1218 depicted and described with respect to FIG. 12), wherein a first DRX-on cycle after the WUS is configured for the one or more first DRX-on cycles and one or more DRX-on cycles after the first DRX-on cycle are configured for the one or more second DRX-on cycles.

In some aspects, method 1500 further includes obtaining an indication of an amount of the one or more DRX-on cycles after the first DRX-on cycle that are configured for the one or more second DRX-on cycles, or the amount of the one or more DRX-on cycles after the first DRX-on cycle that are configured for the one or more second DRX-on cycles comprises a pre-defined value.

In some aspects, method 1500 further includes obtaining an indication that enables CSI prediction for the one or more second DRX-on cycles based on the WUS.

In some aspects, block 1510 includes sending the CSI measurements and the CSI predictions in a same CSI measurement report (e.g., CSI report(s) 1216 depicted and described with respect to FIG. 12) during a CSI reporting occasion associated with the one or more first DRX-on cycles.

In some aspects, the CSI predictions are multiplexed with the CSI measurements in the same CSI measurement report.

In some aspects, block 1510 includes: sending the CSI measurements during one or more first CSI reporting occasions associated with the one or more first DRX-on cycles (e.g., via the CSI report(s) 1216 depicted and described with respect to FIG. 12); and sending the CSI predictions during one or more second CSI reporting occasions associated with the one or more second DRX-on cycles (e.g., via the CSI report(s) 1216 depicted and described with respect to FIG. 12).

In some aspects, the CSI predictions are associated with: a first measurement resource (e.g., of the one or more channel and/or interference measurement resources 1212 as depicted and described with respect to FIG. 12) configured in each DRX-on cycle of the one or more second DRX-on cycles, a plurality of measurement resources (e.g., the one or more channel and/or interference measurement resources 1212 as depicted and described with respect to FIG. 12) configured in each DRX-on cycle of the one or more second DRX-on cycles, or a subset of the plurality of measurement resources configured in each DRX-on cycle of the one or more second DRX-on cycles.

In some aspects, method 1500 further includes obtaining an indication of an amount of the subset of the plurality of measurement resources configured in each DRX-on cycle of the one or more second DRX-on cycles, or the amount of the subset of the plurality of measurement resources configured in each DRX-on cycle of the one or more second DRX-on cycles comprises a pre-defined value.

In some aspects, method 1500 further includes sending a recommendation message (e.g., the message 1220 depicted and described with respect to FIG. 12) comprising one or more of: whether to perform the CSI predictions for one or more DRX-on cycles, an indication of the one or more DRX-on cycles for the CSI predictions, parameters for the one or more second DRX-on cycles, a prediction type for the CSI predictions for the one or more DRX-on cycles, or an information type for the CSI predictions for the one or more DRX-on cycles.

In some aspects, method 1500 further includes sending a capability message (e.g., the message 1220 depicted and described with respect to FIG. 12) comprising one or more of: a capability of the UE to perform the CSI predictions, an amount of one or more DRX-on cycles supported for the CSI predictions, parameters that are supported for the one or more second DRX-on cycles, a prediction type supported by the UE for the CSI predictions for the one or more DRX-on cycles, or an information type supported by the UE for the CSI predictions for the one or more DRX-on cycles.

In some aspects, the CSI predictions comprise one or more of: a channel measurement prediction, an interference measurement prediction, a CRI prediction, a SSBRI prediction, a RSRP prediction, a SINR prediction, a CQI prediction, a PMI prediction, a RI prediction, or a MCS prediction (e.g., based on the AI/ML model 1214 depicted and described with respect to FIG. 12).

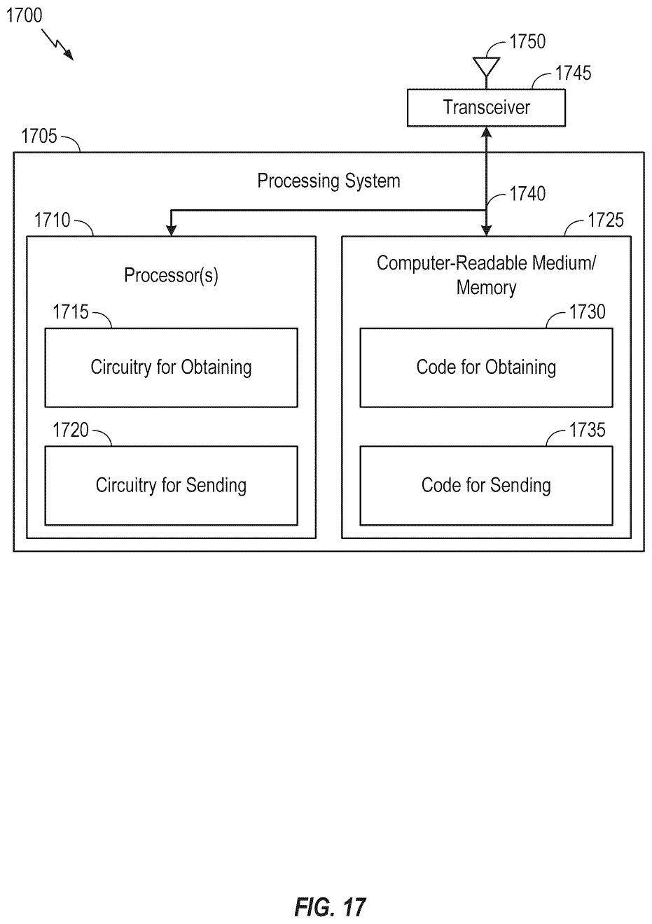

In some aspects, method 1500, or any aspect related to it, may be performed by an apparatus, such as communications device 1700 of FIG. 17, which includes various components operable, configured, or adapted to perform the method 1500. Communications device 1700 is described below in further detail.

Note that FIG. 15 is just one example of a method, and other methods including fewer, additional, or alternative operations are possible consistent with this disclosure.

In certain aspects, method 1500 may be performed by the apparatus to realize one or more technical effects or solutions to the aforementioned technical problem(s). For example, based on method 1500, the apparatus may utilize AI/ML models to predict CSI during deactivated DRX-on durations. The techniques for predicting CSI during deactivated DRX-on durations may enable improved wireless communications performance, such as reduced power consumption at the apparatus and improved tracking of channel conditions. The reduced power consumption and improved tracking of channel conditions may be attributable to the CSI predictions during deactivated DRX-on durations described herein, for example, due to the apparatus not waking up during the prediction DRX-on cycles to save power and a network entity obtaining continuous updates about measured and predicted CSI measurements

### Example Operations of a Network Entity

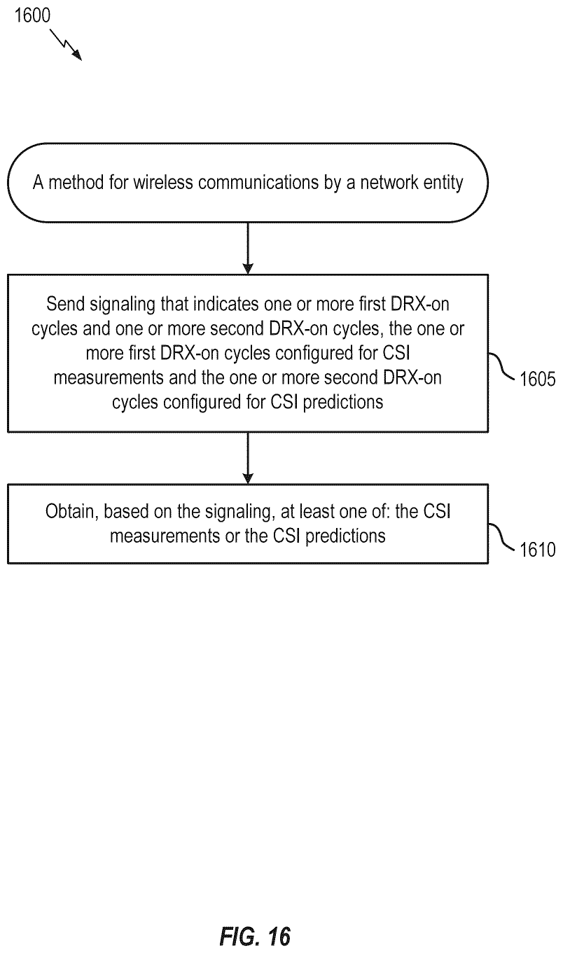

FIG. 16 shows a method 1600 for wireless communications by a network entity, such as BS 102 of FIG. 1 a first network entity 300 or second network entity 302 of FIG. 3, or a disaggregated base station as discussed with respect to FIG. 2.

Method 1600 begins at block 1605 with sending signaling (e.g., the signaling 1210 depicted and described with respect to FIG. 12) that indicates one or more first DRX-on cycles and one or more second DRX-on cycles, the one or more first DRX-on cycles configured for CSI measurements and the one or more second DRX-on cycles configured for CSI predictions.

Method 1600 then proceeds to block 1610 with obtaining (e.g., via the CSI report(s) 1216 depicted and described with respect to FIG. 12), based on the signaling, at least one of: the CSI measurements or the CSI predictions.

In some aspects, block 1605 includes sending a first configuration for the one or more first DRX-on cycles and a second configuration for the one or more second DRX-on cycles.

In some aspects, the first configuration comprises a first set of parameters for the one or more first DRX-on cycles and the second configuration comprises a second set of parameters for the one or more second DRX-on cycles, and the first set of parameters is different than the second set of parameters.

In some aspects, the first configuration comprises a first set of parameters for the one or more first DRX-on cycles and the second configuration comprises a second set of parameters for the one or more second DRX-on cycles, and at least one parameter of the first set of parameters is the same as a parameter of the second set of parameters.

In some aspects, the first configuration comprises a first periodicity for the one or more first DRX-on cycles and the second configuration comprises a second periodicity for the one or more second DRX-on cycles, and the second periodicity is shorter than the first periodicity.

In some aspects, the second periodicity corresponds to a multiple integer amount of cycles for the one or more second DRX-on cycles for each cycle of the one or more first DRX-on cycles.

In some aspects, block 1605 includes sending a first configuration for the one or more first DRX-on cycles, wherein a second configuration for the one or more second DRX-on cycles is based on the first configuration.

In some aspects, the first configuration comprises a parameter to indicate an amount of cycles for the one or more second DRX-on cycles for each cycle of the one or more first DRX-on cycles.

In certain aspects, method 1600 further includes sending, during a first DRX-on cycle of the one or more first DRX-on cycles, an indication that a next occurring DRX-on cycle after the first DRX-on cycle is configured for the one or more second DRX-on cycles.

In certain aspects, method 1600 further includes sending, during a first DRX-on cycle of the one or more first DRX-on cycles, an indication that one or more next occurring DRX-on cycles after the first DRX-on cycle are configured for the one or more first DRX-on cycles or the one or more second DRX-on cycles.

In certain aspects, method 1600 further includes sending respective index values for the one or more first DRX-on cycles and the one or more second DRX-on cycles.

In some aspects, block 1605 includes sending a WUS (e.g., the WU S(s) 1218 depicted and described with respect to FIG. 12), wherein a first DRX-on cycle after the WUS is configured for the one or more first DRX-on cycles and one or more DRX-on cycles after the first DRX-on cycle are configured for the one or more second DRX-on cycles.

In certain aspects, method 1600 further includes sending an indication of an amount of the one or more DRX-on cycles after the first DRX-on cycle that are configured for the one or more second DRX-on cycles, or the amount of the one or more DRX-on cycles after the first DRX-on cycle that are configured for the one or more second DRX-on cycles comprises a pre-defined value.

In certain aspects, method 1600 further includes sending an indication that enables CSI prediction for the one or more second DRX-on cycles based on the WUS.

In some aspects, block 1610 includes obtaining the CSI measurements and the CSI predictions in a same CSI measurement report (e.g., the CSI report(s) 1216 depicted and described with respect to FIG. 12) during a CSI reporting occasion associated with the one or more first DRX-on cycles.

In some aspects, the CSI predictions are multiplexed with the CSI measurements in the same CSI measurement report.

In some aspects, block 1610 includes: obtaining the CSI measurements during one or more first CSI reporting occasions associated with the one or more first DRX-on cycles (e.g., via the CSI report(s) 1216 depicted and described with respect to FIG. 12); and obtaining the CSI predictions during one or more second CSI reporting occasions associated with the one or more second DRX-on cycles (e.g., via the CSI report(s) 1216 depicted and described with respect to FIG. 12).

In some aspects, the CSI predictions are associated with: a first measurement resource (e.g., of the one or more channel and/or interference measurement resources 1212 as depicted and described with respect to FIG. 12) configured in each DRX-on cycle of the one or more second DRX-on cycles, a plurality of measurement resources (e.g., the one or more channel and/or interference measurement resources 1212 as depicted and described with respect to FIG. 12) configured in each DRX-on cycle of the one or more second DRX-on cycles, or a subset of the plurality of measurement resources configured in each DRX-on cycle of the one or more second DRX-on cycles.

In certain aspects, method 1600 further includes sending an indication of an amount of the subset of the plurality of measurement resources configured in each DRX-on cycle of the one or more second DRX-on cycles, or the amount of the subset of the plurality of measurement resources configured in each DRX-on cycle of the one or more second DRX-on cycles comprises a pre-defined value.

In certain aspects, method 1600 further includes obtaining, from a UE, a recommendation message (e.g., the message 1220 depicted and described with respect to FIG. 12) comprising one or more of: whether the UE recommends to perform the CSI predictions for one or more DRX-on cycles, an indication of the one or more DRX-on cycles for the CSI predictions, parameters for the one or more second DRX-on cycles, a prediction type for the CSI predictions for the one or more DRX-on cycles, or an information type for the CSI predictions for the one or more DRX-on cycles.

In certain aspects, method 1600 further includes obtaining, from a UE, a capability message (e.g., the message 1220 depicted and described with respect to FIG. 12) comprising one or more of: a capability of the UE to perform the CSI predictions, an amount of one or more DRX-on cycles supported for the CSI predictions, parameters that are supported for the one or more second DRX-on cycles, a prediction type supported by the UE for the CSI predictions for the one or more DRX-on cycles, or an information type supported by the UE for the CSI predictions for the one or more DRX-on cycles.

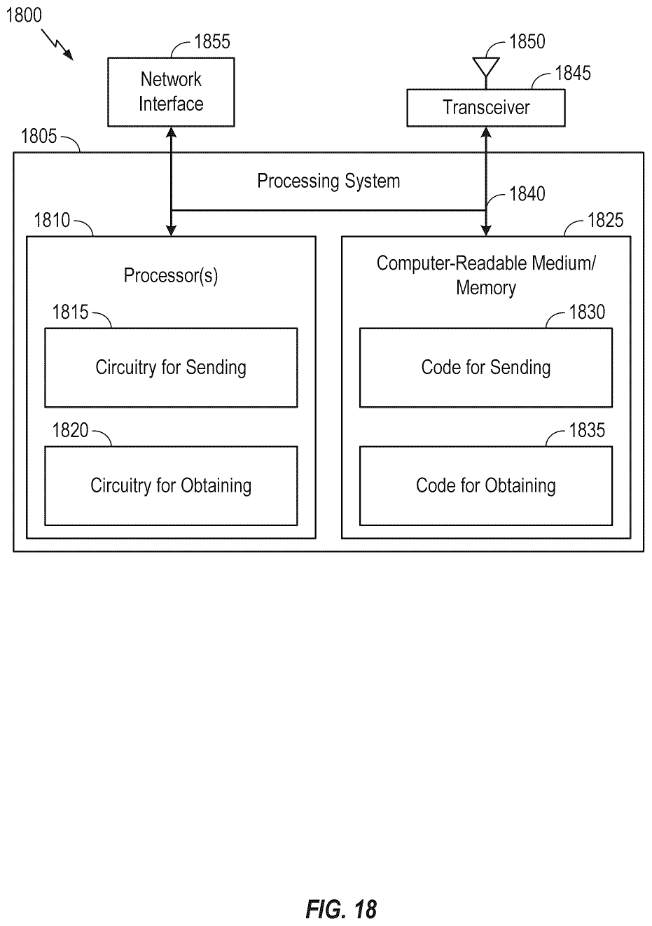

In some aspects, method 1600, or any aspect related to it, may be performed by an apparatus, such as communications device 1800 of FIG. 18, which includes various components operable, configured, or adapted to perform the method 1600. Communications device 1800 is described below in further detail.

Note that FIG. 16 is just one example of a method, and other methods including fewer, additional, or alternative operations are possible consistent with this disclosure.

In certain aspects, method 1600 may be performed by the apparatus to realize one or more technical effects or solutions to the aforementioned technical problem(s). For example, based on method 1600, the apparatus may enable a UE to utilize AI/ML models to predict CSI during deactivated DRX-on durations. The techniques for predicting CSI during deactivated DRX-on durations may enable improved wireless communications performance, such as reduced power consumption and improved tracking of channel conditions. The reduced power consumption and improved tracking of channel conditions may be attributable to the CSI predictions during deactivated DRX-on durations described herein, for example, due to the UE not waking up during the prediction DRX-on cycles to save power and the apparatus obtaining continuous updates about measured and predicted CSI measurements

### Example Communications Devices

FIG. 17 depicts aspects of an example communications device 1700 configured for wireless communications. In some aspects, communications device 1700 is a user equipment, such as UE 104 described above with respect to FIG. 10r UE 304 described with respect to FIG. 3.

The communications device 1700 includes a processing system 1705 coupled to a transceiver 1745 (e.g., a transmitter and/or a receiver). The transceiver 1745 is configured to transmit and receive signals for the communications device 1700 via an antenna 1750, such as the various signals as described herein. The processing system 1705 may be configured to perform processing functions for the communications device 1700, including processing signals received and/or to be transmitted by the communications device 1700.

The processing system 1705 includes one or more processors 1710 and a computer-readable medium/memory 1725. In various aspects, the one or more processors 1710 may be representative of the one or more processors 318 described with respect to FIG. 3. The one or more processors 1710 are coupled to a computer-readable medium/memory 1725 via a bus 1740. In some aspects, the computer-readable medium/memory 1725 may be representative of the one or more memories 320 described with respect to FIG. 3. The computer-readable medium/memory 1725 is a non-transitory computer-readable medium/memory. In certain aspects, the computer-readable medium/memory 1725 is configured to store instructions (e.g., computer-executable code), that when executed by the one or more processors 1710, cause the one or more processors 1710 to perform the method 1500 described with respect to FIG. 15, or any aspect related to it, including any operations described in relation to FIG. 15. Note that reference to a processor performing a function of communications device 1700 may include one or more processors performing that function of communications device 1700, such as in a distributed fashion.

In the depicted example, computer-readable medium/memory 1725 stores code (e.g., executable instructions), including code for obtaining 1730 and code for sending 1735. Processing of the code 1730 and 1735 may enable and cause the communications device 1700 to perform the method 1500 described with respect to FIG. 15, or any aspect related to it. For instance, code for obtaining 1730 includes code for obtaining signaling that indicates one or more first DRX-on cycles and one or more second DRX-on cycles, the one or more first DRX-on cycles configured for CSI measurements and the one or more second DRX-on cycles configured for CSI predictions. In some aspects, code for sending 1735 includes code for sending, based on the signaling, at least one of: the CSI measurements or the CSI predictions.

The one or more processors 1710 include circuitry configured to implement (e.g., execute) the code stored in the computer-readable medium/memory 1725, including circuitry for obtaining 1715 and circuitry for sending 1720. Processing with circuitry 1715 and 1720 may enable and cause the communications device 1700 to perform the method 1500 described with respect to FIG. 15, or any aspect related to it. For instance, circuitry for obtaining 1715 includes circuitry for obtaining signaling that indicates one or more first DRX-on cycles and one or more second DRX-on cycles, the one or more first DRX-on cycles configured for CSI measurements and the one or more second DRX-on cycles configured for CSI predictions. In some aspects, circuitry for sending 1720 includes circuitry for sending, based on the signaling, at least one of: the CSI measurements or the CSI predictions.

More generally, means for communicating, transmitting, sending or outputting for transmission may include the one or more transceivers 324, one or more antenna 322 and/or processing system 316 of the UE 304 illustrated in FIG. 3, transceiver 1745 and/or antenna 1750 of the communications device 1700 in FIG. 17, and/or one or more processors 1710 of the communications device 1700 in FIG. 17. Means for communicating, receiving or obtaining may include the one or more transceivers 324, one or more antennas 322, and/or processing system 316 of the UE 304 illustrated in FIG. 3, transceiver 1745 and/or antenna 1750 of the communications device 1700 in FIG. 17, and/or one or more processors 1710 of the communications device 1700 in FIG. 17.

FIG. 18 depicts aspects of an example communications device configured for wireless communications. In some aspects, communications device 1800 is a network entity, such as BS 102 of FIG. 1, first network entity 300 or second network entity 302 of FIG. 3, or a disaggregated base station as discussed with respect to FIG. 2.

The communications device 1800 includes a processing system 1805 coupled to a transceiver 1845 (e.g., a transmitter and/or a receiver) and/or a network interface 1855. The transceiver 1845 is configured to transmit and receive signals for the communications device 1800 via an antenna 1850, such as the various signals as described herein. The network interface 1855 is configured to obtain and send signals for the communications device 1800 via communications link(s), such as a backhaul link, midhaul link, and/or fronthaul link as described herein, such as with respect to FIG. 2 The processing system 1805 may be configured to perform processing functions for the communications device 1800, including processing signals received and/or to be transmitted by the communications device 1800.

The processing system 1805 includes one or more processors 1810 and a computer-readable medium/memory 1825. In various aspects, one or more processors 1810 may be representative of the one or more processors 308, as described with respect to FIG. 3. The one or more processors 1810 are coupled to the computer-readable medium/memory 1825 via a bus 1840. In certain aspects, the computer-readable medium/memory 1825 is configured to store instructions (e.g., computer-executable code), including code 1830 and 1835, that when executed by the one or more processors 1810, cause the one or more processors 1810 to perform the method 1600 described with respect to FIG. 16, or any aspect related to it, including any operations described in relation to FIG. 16. The computer-readable medium/memory 1825 is a non-transitory computer-readable medium/memory. Note that reference to a processor of communications device 1800 performing a function may include one or more processors of communications device 1800 performing that function, such as in a distributed fashion.

In the depicted example, the computer-readable medium/memory 1825 stores code (e.g., executable instructions), including code for sending 1830 and code for obtaining 1835. Processing of the code 1830 and 1835 may enable and cause the communications device 1800 to perform the method 1600 described with respect to FIG. 16, or any aspect related to it. For instance, in some aspects, code for sending 1830 includes code for sending that indicates one or more first DRX-on cycles and one or more second DRX-on cycles, the one or more first DRX-on cycles configured for CSI measurements and the one or more second DRX-on cycles configured for CSI predictions. In some aspects, code for obtaining 1835 includes code for obtaining the CSI measurements and the CSI predictions based on the signaling.

The one or more processors 1810 include circuitry configured to implement (e.g., execute) the code stored in the computer-readable medium/memory 1825, including circuitry for sending 1815 and circuitry for obtaining 1820. Processing with circuitry 1815 and 1820 may enable and cause the communications device 1800 to perform the method 1600 described with respect to FIG. 16, or any aspect related to it. For instance, in some aspects, circuitry for sending 1815 includes circuitry for sending that indicates one or more first DRX-on cycles and one or more second DRX-on cycles, the one or more first DRX-on cycles configured for CSI measurements and the one or more second DRX-on cycles configured for CSI predictions. In some aspects, circuitry for obtaining 1820 includes circuitry for obtaining the CSI measurements and the CSI predictions based on the signaling.

Various components of the communications device 1800 may provide means for performing the method 1600 described with respect to FIG. 16, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1845, antenna 1850, and/or network interface 1855 of the communications device 1800 in FIG. 18, and/or one or more processors 1810 of the communications device 1800 in FIG. 18. Means for communicating, receiving or obtaining may include the one or more transceivers 312, one or more antennas 314, and/or processing system 306 of the first network entity 300 or the second network entity 302 illustrated in FIG. 3, transceiver 1845, antenna 1850, and/or network interface 1855 of the communications device 1800 in FIG. 18, and/or one or more processors 1810 of the communications device 1800 in FIG. 18

### Example Clauses

Implementation examples are described in the following numbered clauses:

Clause 1: A method for wireless communications by a UE comprising: obtaining signaling that indicates one or more first DRX-on cycles and one or more second DRX-on cycles, the one or more first DRX-on cycles configured for CSI measurements and the one or more second DRX-on cycles configured for CSI predictions; and sending, based on the signaling, at least one of: the CSI measurements or the CSI predictions.

Clause 2: The method of Clause 1, wherein obtaining the signaling comprises obtaining a first configuration for the one or more first DRX-on cycles and a second configuration for the one or more second DRX-on cycles.

Clause 3: The method of Clause 2, wherein: the first configuration comprises a first set of parameters for the one or more first DRX-on cycles and the second configuration comprises a second set of parameters for the one or more second DRX-on cycles, and the first set of parameters is different than the second set of parameters.

Clause 4: The method of Clause 2, wherein: the first configuration comprises a first set of parameters for the one or more first DRX-on cycles and the second configuration comprises a second set of parameters for the one or more second DRX-on cycles, and at least one parameter of the first set of parameters is the same as a parameter of the second set of parameters.

Clause 5: The method of Clause 2, wherein: the first configuration comprises a first periodicity for the one or more first DRX-on cycles and the second configuration comprises a second periodicity for the one or more second DRX-on cycles, and the second periodicity is shorter than the first periodicity.

Clause 6: The method of Clause 5, wherein the second periodicity corresponds to a multiple integer amount of cycles for the one or more second DRX-on cycles for each cycle of the one or more first DRX-on cycles.

Clause 7: The method of any one of Clauses 1-6, wherein obtaining the signaling comprises obtaining a first configuration for the one or more first DRX-on cycles, wherein a second configuration for the one or more second DRX-on cycles is based on the first configuration.

Clause 8: The method of Clause 7, wherein the first configuration comprises a parameter to indicate an amount of cycles for the one or more second DRX-on cycles for each cycle of the one or more first DRX-on cycles.

Clause 9: The method of Clause 7, further comprising obtaining, during a first DRX-on cycle of the one or more first DRX-on cycles, an indication that a next occurring DRX-on cycle after the first DRX-on cycle is configured for the one or more second DRX-on cycles.

Clause 10: The method of Clause 7, further comprising obtaining, during a first DRX-on cycle of the one or more first DRX-on cycles, an indication that one or more next occurring DRX-on cycles after the first DRX-on cycle are configured for the one or more first DRX-on cycles or the one or more second DRX-on cycles.

Clause 11: The method of Clause 7, further comprising obtaining respective index values for the one or more first DRX-on cycles and the one or more second DRX-on cycles.

Clause 12: The method of any one of Clauses 1-11, wherein obtaining the signaling comprises obtaining a WUS, wherein a first DRX-on cycle after the WUS is configured for the one or more first DRX-on cycles and one or more DRX-on cycles after the first DRX-on cycle are configured for the one or more second DRX-on cycles.

Clause 13: The method of Clause 12, further comprising obtaining an indication of an amount of the one or more DRX-on cycles after the first DRX-on cycle that are configured for the one or more second DRX-on cycles, or the amount of the one or more DRX-on cycles after the first DRX-on cycle that are configured for the one or more second DRX-on cycles comprises a pre-defined value.

Clause 14: The method of Clause 12, further comprising obtaining an indication that enables CSI prediction for the one or more second DRX-on cycles based on the WUS.

Clause 15: The method of any one of Clauses 1-14, wherein sending at least one of: the CSI measurements or the CSI predictions comprises sending the CSI measurements and the CSI predictions in a same CSI measurement report during a CSI reporting occasion associated with the one or more first DRX-on cycles.

Clause 16: The method of Clause 15, wherein the CSI predictions are multiplexed with the CSI measurements in the same CSI measurement report.

Clause 17: The method of any one of Clauses 1-16, wherein sending at least one of: the CSI measurements or the CSI predictions comprises: sending the CSI measurements during one or more first CSI reporting occasions associated with the one or more first DRX-on cycles; and sending the CSI predictions during one or more second CSI reporting occasions associated with the one or more second DRX-on cycles.

Clause 18: The method of any one of Clauses 1-17, wherein the CSI predictions are associated with: a first measurement resource configured in each DRX-on cycle of the one or more second DRX-on cycles, a plurality of measurement resources configured in each DRX-on cycle of the one or more second DRX-on cycles, or a subset of the plurality of measurement resources configured in each DRX-on cycle of the one or more second DRX-on cycles.

Clause 19: The method of Clause 18, further comprising obtaining an indication of an amount of the subset of the plurality of measurement resources configured in each DRX-on cycle of the one or more second DRX-on cycles, or the amount of the subset of the plurality of measurement resources configured in each DRX-on cycle of the one or more second DRX-on cycles comprises a pre-defined value.

Clause 20: The method of any one of Clauses 1-19, further comprising sending a recommendation message comprising one or more of: whether to perform the CSI predictions for one or more DRX-on cycles, an indication of the one or more DRX-on cycles for the CSI predictions, parameters for the one or more second DRX-on cycles, a prediction type for the CSI predictions for the one or more DRX-on cycles, or an information type for the CSI predictions for the one or more DRX-on cycles.

Clause 21: The method of any one of Clauses 1-20, further comprising sending a capability message comprising one or more of: a capability of the UE to perform the CSI predictions, an amount of one or more DRX-on cycles supported for the CSI predictions, parameters that are supported for the one or more second DRX-on cycles, a prediction type supported by the UE for the CSI predictions for the one or more DRX-on cycles, or an information type supported by the UE for the CSI predictions for the one or more DRX-on cycles.

Clause 22: The method of any one of Clauses 1-21, wherein the CSI predictions comprise one or more of: a channel measurement prediction, an interference measurement prediction, a CRI prediction, a SSBRI prediction, a RSRP prediction, a SINR prediction, a CQI prediction, a PMI prediction, a RI prediction, or a MCS prediction.

Clause 23: A method for wireless communications by a network entity comprising: sending signaling that indicates one or more first DRX-on cycles and one or more second DRX-on cycles, the one or more first DRX-on cycles configured for CSI measurements and the one or more second DRX-on cycles configured for CSI predictions; and obtaining, based on the signaling, at least one of: the CSI measurements or the CSI predictions.

Clause 24: The method of Clause 23, wherein sending the signaling comprises sending a first configuration for the one or more first DRX-on cycles and a second configuration for the one or more second DRX-on cycles.

Clause 25: The method of Clause 24, wherein: the first configuration comprises a first set of parameters for the one or more first DRX-on cycles and the second configuration comprises a second set of parameters for the one or more second DRX-on cycles, and the first set of parameters is different than the second set of parameters.

Clause 26: The method of Clause 24, wherein: the first configuration comprises a first set of parameters for the one or more first DRX-on cycles and the second configuration comprises a second set of parameters for the one or more second DRX-on cycles, and at least one parameter of the first set of parameters is the same as a parameter of the second set of parameters.

Clause 27: The method of Clause 24, wherein: the first configuration comprises a first periodicity for the one or more first DRX-on cycles and the second configuration comprises a second periodicity for the one or more second DRX-on cycles, and the second periodicity is shorter than the first periodicity.

Clause 28: The method of Clause 27, wherein the second periodicity corresponds to a multiple integer amount of cycles for the one or more second DRX-on cycles for each cycle of the one or more first DRX-on cycles.

Clause 29: The method of any one of Clauses 23-28, wherein sending the signaling comprises sending a first configuration for the one or more first DRX-on cycles, wherein a second configuration for the one or more second DRX-on cycles is based on the first configuration.

Clause 30: The method of Clause 29, wherein the first configuration comprises a parameter to indicate an amount of cycles for the one or more second DRX-on cycles for each cycle of the one or more first DRX-on cycles.

Clause 31: The method of Clause 29, further comprising sending, during a first DRX-on cycle of the one or more first DRX-on cycles, an indication that a next occurring DRX-on cycle after the first DRX-on cycle is configured for the one or more second DRX-on cycles.

Clause 32: The method of Clause 29, further comprising sending, during a first DRX-on cycle of the one or more first DRX-on cycles, an indication that one or more next occurring DRX-on cycles after the first DRX-on cycle are configured for the one or more first DRX-on cycles or the one or more second DRX-on cycles.

Clause 33: The method of Clause 29, further comprising sending respective index values for the one or more first DRX-on cycles and the one or more second DRX-on cycles.

Clause 34: The method of any one of Clauses 23-33, wherein sending the signaling comprises sending a WUS, wherein a first DRX-on cycle after the WUS is configured for the one or more first DRX-on cycles and one or more DRX-on cycles after the first DRX-on cycle are configured for the one or more second DRX-on cycles.

Clause 35: The method of Clause 34, further comprising sending an indication of an amount of the one or more DRX-on cycles after the first DRX-on cycle that are configured for the one or more second DRX-on cycles, or the amount of the one or more DRX-on cycles after the first DRX-on cycle that are configured for the one or more second DRX-on cycles comprises a pre-defined value.

Clause 36: The method of Clause 34, further comprising sending an indication that enables CSI prediction for the one or more second DRX-on cycles based on the WUS.

Clause 37: The method of any one of Clauses 23-36, wherein obtaining at least one of: the CSI measurements or the CSI predictions comprises obtaining the CSI measurements and the CSI predictions in a same CSI measurement report during a CSI reporting occasion associated with the one or more first DRX-on cycles.

Clause 38: The method of Clause 37, wherein the CSI predictions are multiplexed with the CSI measurements in the same CSI measurement report.

Clause 39: The method of any one of Clauses 23-38, wherein obtaining at least one of: the CSI measurements or the CSI predictions comprises: obtaining the CSI measurements during one or more first CSI reporting occasions associated with the one or more first DRX-on cycles; and obtaining the CSI predictions during one or more second CSI reporting occasions associated with the one or more second DRX-on cycles.

Clause 40: The method of any one of Clauses 23-39, wherein the CSI predictions are associated with: a first measurement resource configured in each DRX-on cycle of the one or more second DRX-on cycles, a plurality of measurement resources configured in each DRX-on cycle of the one or more second DRX-on cycles, or a subset of the plurality of measurement resources configured in each DRX-on cycle of the one or more second DRX-on cycles.

Clause 41: The method of Clause 40, further comprising sending an indication of an amount of the subset of the plurality of measurement resources configured in each DRX-on cycle of the one or more second DRX-on cycles, or the amount of the subset of the plurality of measurement resources configured in each DRX-on cycle of the one or more second DRX-on cycles comprises a pre-defined value.

Clause 42: The method of any one of Clauses 23-41, further comprising obtaining, from a UE, a recommendation message comprising one or more of: whether the UE recommends to perform the CSI predictions for one or more DRX-on cycles, an indication of the one or more DRX-on cycles for the CSI predictions, parameters for the one or more second DRX-on cycles, a prediction type for the CSI predictions for the one or more DRX-on cycles, or an information type for the CSI predictions for the one or more DRX-on cycles.

Clause 43: The method of any one of Clauses 23-42, further comprising obtaining, from a UE, a capability message comprising one or more of: a capability of the UE to perform the CSI predictions, an amount of one or more DRX-on cycles supported for the CSI predictions, parameters that are supported for the one or more second DRX-on cycles, a prediction type supported by the UE for the CSI predictions for the one or more DRX-on cycles, or an information type supported by the UE for the CSI predictions for the one or more DRX-on cycles.

Clause 44: One or more apparatuses, comprising: one or more memories comprising executable instructions; and one or more processors configured to execute the executable instructions and cause the one or more apparatuses to perform a method in accordance with any one of Clauses 1-43.

Clause 45: One or more apparatuses configured for wireless communications, comprising: one or more memories; and one or more processors, coupled to the one or more memories, configured to cause the one or more apparatuses to perform a method in accordance with any one of Clauses 1-43.

Clause 46: One or more apparatuses configured for wireless communications, comprising: one or more memories; and one or more processors, coupled to the one or more memories, configured to perform a method in accordance with any one of Clauses 1-43.

Clause 47: One or more apparatuses, comprising means for performing a method in accordance with any one of Clauses 1-43.

Clause 48: One or more non-transitory computer-readable media comprising executable instructions that, when executed by one or more processors of one or more apparatuses, cause the one or more apparatuses to perform a method in accordance with any one of Clauses 1-43.

Clause 49: One or more computer program products embodied on one or more computer-readable storage media comprising code for performing a method in accordance with any one of Clauses 1-43.

Clause 50: One or more apparatuses configured for wireless communications, comprising: a processing system that includes one or more processors and one or more memories coupled with the one or more processors, the processing system configured to cause the one or more apparatuses to perform a method in accordance with any one of Clauses 1-43.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an A SIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising: a processing system that includes one or more processors and one or more memories coupled with the one or more processors, the processing system configured to cause a user equipment (UE) to:
obtain signaling that indicates one or more first discontinuous reception (DRX)-on cycles and one or more second DRX-on cycles, the one or more first DRX-on cycles configured for channel state information (CSI) measurements and the one or more second DRX-on cycles configured for CSI predictions; and
send, based on the signaling, at least one of: the CSI measurements or the CSI predictions.

2. The apparatus of claim 1, wherein to cause the UE to obtain the signaling, the processing system is configured to cause the UE to obtain a first configuration for the one or more first DRX-on cycles and a second configuration for the one or more second DRX-on cycles.

3. The apparatus of claim 2, wherein:
the first configuration comprises a first set of parameters for the one or more first DRX-on cycles,
the second configuration comprises a second set of parameters for the one or more second DRX-on cycles, and
the first set of parameters is different than the second set of parameters.

4. The apparatus of claim 2, wherein:
the first configuration comprises a first set of parameters for the one or more first DRX-on cycles,
the second configuration comprises a second set of parameters for the one or more second DRX-on cycles, and
at least one parameter of the first set of parameters is the same as a parameter of the second set of parameters.

5. The apparatus of claim 2, wherein:
the first configuration comprises a first periodicity for the one or more first DRX-on cycles,
the second configuration comprises a second periodicity for the one or more second DRX-on cycles, and
the second periodicity is shorter than the first periodicity.

6. The apparatus of claim 1, wherein to cause the UE to obtain the signaling, the processing system is configured to cause the UE to obtain a first configuration for the one or more first DRX-on cycles, wherein a second configuration for the one or more second DRX-on cycles is based on the first configuration.

7. The apparatus of claim 6, wherein the first configuration comprises a parameter to indicate an amount of cycles for the one or more second DRX-on cycles for each cycle of the one or more first DRX-on cycles.

8. The apparatus of claim 6, wherein the processing system is configured to cause the UE to obtain, during a first DRX-on cycle of the one or more first DRX-on cycles, an indication that a next occurring DRX-on cycle after the first DRX-on cycle is configured for the one or more second DRX-on cycles.

9. The apparatus of claim 6, wherein the processing system is configured to cause the UE to obtain, during a first DRX-on cycle of the one or more first DRX-on cycles, an indication that one or more next occurring DRX-on cycles after the first DRX-on cycle are configured for the one or more first DRX-on cycles or the one or more second DRX-on cycles.

10. The apparatus of claim 6, wherein the processing system is configured to cause the UE to obtain respective index values for the one or more first DRX-on cycles and the one or more second DRX-on cycles.

11. The apparatus of claim 1, wherein to cause the UE to obtain the signaling, the processing system is configured to cause the UE to obtain a wake-up signal (WUS), wherein a first DRX-on cycle after the WUS is configured for the one or more first DRX-on cycles and one or more DRX-on cycles after the first DRX-on cycle are configured for the one or more second DRX-on cycles.

12. The apparatus of claim 11, wherein the processing system is configured to cause the UE to obtain an indication that enables CSI prediction for the one or more second DRX-on cycles based on the WUS.

13. The apparatus of claim 1, wherein to cause the UE to send at least one of: the CSI measurements or the CSI predictions, the processing system is configured to cause the UE to send the CSI measurements and the CSI predictions in a same CSI measurement report during a CSI reporting occasion associated with the one or more first DRX-on cycles.

14. The apparatus of claim 1, wherein to cause the UE to send at least one of: the CSI measurements or the CSI predictions, the processing system is configured to cause the UE to:
send the CSI measurements during one or more first CSI reporting occasions associated with the one or more first DRX-on cycles; and
send the CSI predictions during one or more second CSI reporting occasions associated with the one or more second DRX-on cycles.

15. The apparatus of claim 1, wherein the CSI predictions are associated with:
a first measurement resource configured in each DRX-on cycle of the one or more second DRX-on cycles,
a plurality of measurement resources configured in each DRX-on cycle of the one or more second DRX-on cycles, or
a subset of the plurality of measurement resources configured in each DRX-on cycle of the one or more second DRX-on cycles.

16. The apparatus of claim 1, wherein the processing system is configured to cause the UE to send a recommendation message comprising one or more of:
whether to perform the CSI predictions for one or more DRX-on cycles, an indication of the one or more DRX-on cycles for the CSI predictions, parameters for the one or more second DRX-on cycles,
a prediction type for the CSI predictions for the one or more DRX-on cycles, or
an information type for the CSI predictions for the one or more DRX-on cycles.

17. The apparatus of claim 1, wherein the processing system is configured to cause the UE to send a capability message comprising one or more of:
a capability of the UE to perform the CSI predictions,
an amount of one or more DRX-on cycles supported for the CSI predictions,
parameters that are supported for the one or more second DRX-on cycles,
a prediction type supported by the UE for the CSI predictions for the one or more DRX-on cycles, or
an information type supported by the UE for the CSI predictions for the one or more DRX-on cycles.

18. The apparatus of claim 1, wherein the CSI predictions comprise one or more of:
a channel measurement prediction,
an interference measurement prediction,
a CSI reference signal (RS) resource indicator (CRI) prediction,
a synchronization signal block resource indicator (SSB RI) prediction,
a reference signal received power (RSRP) prediction,
a signal-to-interference plus noise ratio (SINR) prediction,
a channel quality indicator (CQI) prediction,
a precoding matrix indicator (PMI) prediction,
a rank indicator (RI) prediction, or
a modulation and coding scheme (MCS) prediction.

19. An apparatus for wireless communications, comprising: a processing system that includes one or more processors and one or more memories coupled with the one or more processors, the processing system configured to cause a network entity to:
send signaling that indicates one or more first discontinuous reception (DRX)-on cycles and one or more second DRX-on cycles, the one or more first DRX-on cycles configured for channel state information (CSI) measurements and the one or more second DRX-on cycles configured for CSI predictions; and
obtain the CSI measurements and the CSI predictions based on the signaling.

20. A method for wireless communications by a user equipment (UE) comprising:
obtaining signaling that indicates one or more first discontinuous reception (DRX)-on cycles and one or more second DRX-on cycles, the one or more first DRX-on cycles configured for channel state information (CSI) measurements and the one or more second DRX-on cycles configured for CSI predictions; and
sending the CSI measurements and the CSI predictions based on the signaling.
